(19) United States
(12) Patent Application Publication
(10) Pub. No.: US 2026/0155901 A1
(43) Pub. Date: Jun. 4, 2026

(54) CROWD COUNTING METHOD AND SYSTEM FOR IMPLEMENTING

(71) Applicant: Rakuten Mobile, Inc., Tokyo (JP)

(72) Inventors: Saurabh VERMA, Tokyo (JP); Kelvin CHENG, Tokyo (JP); Hsuehhan WU, Tokyo (JP); Daisuke ICHIHASHI, Tokyo (JP); Masahiko NANRI, Tokyo (JP); Nopphon KEERATIVORANAN, Tokyo (JP); Hang SONG, Tokyo (JP); Junichi TAKADA, Tokyo (JP)

(21) Appl. No.: 18/964,254

(22) Filed: Nov. 29, 2024

(51) Int. Cl. H04B 17/318; H04W 4/029

(52) U.S. Cl. CPC H04B 17/328; H04W 4/029

(57) ABSTRACT

A method includes performing background data collection in a first region at a first time, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. The method further includes performing RSRP data collection in the first region for a second time and performing RSRP data processing for a first database, and performing k-nearest neighbor (kNN) crowd counting based on at least the RSRP data processing. The performing kNN crowd counting includes estimating a number of people in the first region based on at least a second set of normalized statistical features.

### FIELD

The present disclosure relates to a crowd counting method and a system for implementing the method.

### BACKGROUND

Network service providers and device manufacturers (e.g., wireless, cellular, etc.) are continually challenged to deliver value and convenience to consumers by, for example, providing compelling network services that are capable of being flexibly constructed, scalable and diverse. Furthermore, security implemented by network service providers and device manufacturers (e.g., wireless, cellular, etc.) face challenges while protecting privacy of customers or users.

### SUMMARY

According to at least one embodiment, a method includes performing background data collection in a first region at a first time, the first region does not include any humans at the first time. In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. In some embodiments, the method further includes performing RSRP data collection in the first region for a second time and performing RSRP data processing for a first database, the second time is different from the first time, the first region includes N humans at the second time, where N is an integer greater than or equal to 0. In some embodiments, the performing RSRP data collection in the first region for the second time and the performing RSRP data processing for the first database includes determining, for each window of a first set of windows, a first set of statistical features based on a first set of background RSRP normalization data, and determining, for each window of the first set of windows, a first set of normalized statistical features based on at least the first set of statistical features. In some embodiments, the method further includes performing k-nearest neighbor (kNN) crowd counting based on at least the RSRP data processing. In some embodiments, the performing kNN crowd counting includes estimating a number of people in the first region based on at least a second set of normalized statistical features.

According to at least one embodiment a system configured to execute a process. The process includes performing background data collection in a first region at a first time, the first region does not include any humans at the first time. In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. In some embodiments, the method further includes performing RSRP data collection in the first region for a second time and performing RSRP data processing for a first database, the second time is different from the first time, the first region includes N humans at the second time, where N is an integer greater than or equal to 0. In some embodiments, the performing RSRP data collection in the first region for the second time and the performing RSRP data processing for the first database includes determining, for each window of a first set of windows, a first set of statistical features based on a first set of background RSRP normalization data, and determining, for each window of the first set of windows, a first set of normalized statistical features based on at least the first set of statistical features. In some embodiments, the method further includes performing k-nearest neighbor (kNN) crowd counting based on at least the RSRP data processing. In some embodiments, the performing kNN crowd counting includes estimating a number of people in the first region based on at least a second set of normalized statistical features.

According to at least one embodiment a non-transitory computer readable medium configured to cause a system to execute a method. The method includes performing background data collection in a first region at a first time, the first region does not include any humans at the first time. In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. In some embodiments, the method further includes performing RSRP data collection in the first region for a second time and performing RSRP data processing for a first database, the second time is different from the first time, the first region includes N humans at the second time, where N is an integer greater than or equal to 0. In some embodiments, the performing RSRP data collection in the first region for the second time and the performing RSRP data processing for the first database includes determining, for each window of a first set of windows, a first set of statistical features based on a first set of background RSRP normalization data, and determining, for each window of the first set of windows, a first set of normalized statistical features based on at least the first set of statistical features. In some embodiments, the method further includes performing k-nearest neighbor (kNN) crowd counting based on at least the RSRP data processing. In some embodiments, the performing kNN crowd counting includes estimating a number of people in the first region based on at least a second set of normalized statistical features.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a block diagram of a system, in accordance with some embodiments.

FIGS. 2A-2B are a flowchart of a method, in accordance with some embodiments.

FIG. 3 is an exemplary diagram that illustrates operations of the method of FIGS. 2A-2B, in accordance with some embodiments.

FIG. 4 is an exemplary diagram that illustrates operations of the method of FIGS. 2A-2B, in accordance with some embodiments.

FIG. 5 is an exemplary diagram that illustrates operations of the method of FIGS. 2A-2B, in accordance with some embodiments.

FIG. 6 is an exemplary diagram that illustrates operations of the method of FIGS. 2A-2B, in accordance with some embodiments.

FIG. 7 is an exemplary diagram that illustrates operations of the method of FIGS. 2A-2B, in accordance with some embodiments.

FIG. 8 is a flowchart of a method, in accordance with some embodiments.

FIG. 9 is an exemplary diagram that illustrates operations of the method of FIG. 8, in accordance with some embodiments.

FIG. 10 is a block diagram of a system for crowd counting in accordance with at least one embodiment.

FIG. 11 illustrates an embodiment of a device for implementing a crowd counting method in accordance with at least one embodiment.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

Security implemented by network service providers and device manufacturers (e.g., wireless, cellular, etc.) face challenges while protecting privacy of customers or users.

Furthermore, tracking the flow of users in one or more buildings while maintaining the privacy of customers or users is balanced by network service providers and device manufacturers and building owners.

In some embodiments, a crowd counting method includes performing background data collection in a first region at a first time, where the first region does not include any humans at the first time.

In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data.

In some embodiments, the crowd counting method further includes performing RSRP data collection in the first region for a second time and performing RSRP data processing for a first database. In some embodiments, the second time is different from the first time. In some embodiments, the first region includes n humans at the second time, where N is an integer greater than or equal to 0.

In some embodiments, the performing RSRP data collection in the first region for the second time and the performing RSRP data processing for the first database includes determining, for each window of a first set of windows, a first set of statistical features based on a first set of background RSRP normalization data; and determining, for each window of the first set of windows, a first set of normalized statistical features based on at least the first set of statistical features.

In some embodiments, the crowd counting method further includes performing k-nearest neighbor (kNN) crowd counting based on at least the RSRP data processing. In some embodiments, the performing kNN crowd counting includes estimating a number of people in the first region based on at least a second set of normalized statistical features.

In some embodiments, the crowd counting method is configured to estimate a number of people in the first region or count the crowd in the first region thereby providing security to the region without the use of one or more cameras.

In some embodiments, the crowd counting method is configured to estimate the number of people in the first region or count the crowd in the region thereby being able determine if trespassers are present in the first region without the use of one or more cameras thus enhancing the security of the first region.

In some embodiments, the crowd counting method is configured to estimate a number of people in the first region or count the crowd in the first region thereby tracking the locations of the set of users in the first region without the use of one or more cameras.

In some embodiments, the crowd counting method is configured to estimate a number of people in the first region or count the crowd in the first region thereby determining the flow of people in the first region without the use of one or more cameras.

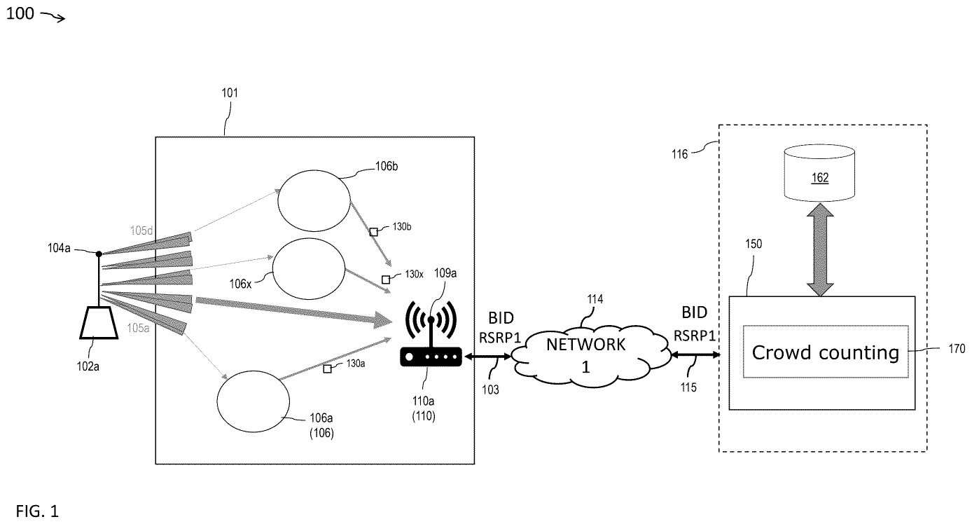

FIG. 1 is a block diagram of a system 100, in accordance with some embodiments.

System 100 includes a set of nodes 102 configured to transmit/receive a set of data 130 with a set of nodes 110.

System 100 further includes a network 114 coupled to the set of nodes 110 by a set of links 103, and the network 114 is further coupled to a set of devices 116 by a link 115.

The set of nodes 110 and the set of devices 116 are coupled to each other by network 114. The set of devices 116 and the set of nodes 110 are configured to transfer data with each other by network 114.

The set of nodes 102 includes at least node 102a. Each node 102a is located in a corresponding cell (not shown) of a set of cells (not shown). In some embodiments, the set of nodes 102 is part of a cellular network. In some embodiments, at least one node of the set of nodes 102 corresponds to a macrocell, a microcell, a picocell, a femtocell, a small cell, or the like.

Each node 102a of the set of nodes 102 is coupled to network 114 by a corresponding link 103a, 103b, . . . , 103l or 103m of the set of links 103.

Each node 102a of the set of nodes 102 includes a set of antennas 104a.

Each node 102a of the set of nodes 102 is configured to transmit/receive data with a corresponding node 110a of the set of nodes 110 by each corresponding set of antennas 104a and each corresponding link 105a, 105b, 105c, 105d of a set of links 105. Other numbers of nodes in the set of nodes 102 or 110 are within the scope of the present disclosure. Other numbers of antennas in the set of antennas 104 are within the scope of the present disclosure.

In some embodiments, each link 105a, 105b, 105c, 105d of the set of links 105 has a corresponding set of beam identifications (beam IDs in FIG. 1) and a corresponding a set of reference signal received power (RSRP) signals RSRP1. Other numbers of links in the set of links 105 are within the scope of the present disclosure.

In some embodiments, the set of beam IDs is usable to identify a corresponding beam of the link 105a, 105b, 105c, 105d of the set of links 105. Other numbers of beams in the set of beam IDs are within the scope of the present disclosure. Other numbers of RSRP signals in the set of RSRP signals RSRP1 are within the scope of the present disclosure.

In some embodiments, at least one node of the set of nodes 102 corresponds to a base transceiver station (BTS), a NodeB, an Evolved NodeB (eNB), a Next Generation NodeB (gNB), or the like.

Other configurations, different types of nodes or other number of nodes in the set of nodes 102 are within the scope of the present disclosure. For example, in some embodiments, other number of nodes are located within at least one or more cells of the set of cells.

The set of antennas 104a is configured to transmit or receive signals with the corresponding set of nodes 110 by each corresponding link 105a, 105b, 105c, 105d of the set of links 105. In some embodiments, one or more links 105a, 105b, 105c or 105d of the set of links 105 are reflected or scattered off of one or more humans 106, and then the reflected or scattered wave is received by the set of nodes 110 as the corresponding one or more links 105a, 105b, 105c or 105d of the set of links 105.

The set of antennas 104a includes one or more antennas.

In some embodiments, at least one set of antennas in the set of antennas 104a corresponds to a panel reflector antenna array. In some embodiments, at least one set of antennas in the set of antennas 104a corresponds to a smart antenna array.

Other configurations or number of antennas in at least the set of antennas 104a, . . . , 104m are within the scope of the present disclosure.

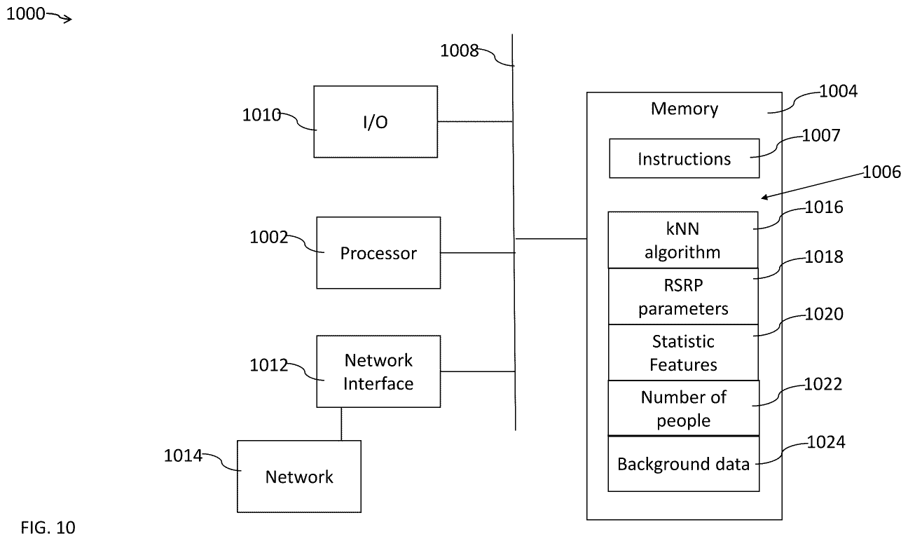

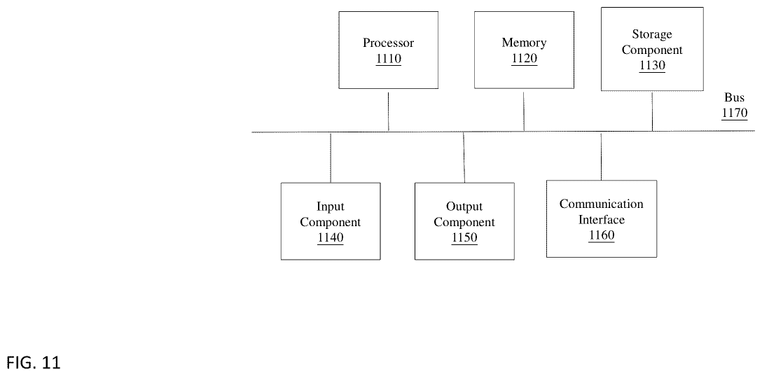

The set of humans 106 includes at least human 106a, 106b, . . . , 106w or 106x, where x is an integer corresponding to a number of humans in the set of humans 106. Other numbers of humans in the set of humans 106 are within the scope of the present disclosure. In some embodiments, one or more humans in the set of humans 106 includes a corresponding device (not shown) of a set of devices, and is shown as system 1000 (FIG. 10) or device 1100 (FIG. 11).

In some embodiments, one or more of the devices of the set of devices (not shown) is a type of mobile terminal, fixed terminal, or portable terminal including a desktop computer, laptop computer, notebook computer, netbook computer, tablet computer, wearable circuitry, mobile handset, server, gaming console, or combinations thereof. In some embodiments, one or more of the devices of the set of devices (not shown) comprises a display by which a user interface is displayed. In some embodiments, the set of devices (not shown) corresponds to a server farm.

In some embodiments, one or more humans 106a, 106b, . . . , 106w or 106x of the set of humans 106 is within a cell. In some embodiments, one or more humans 106a, 106b, . . . , 106w or 106x of the set of humans 106 is configured to reflect or scatter a corresponding link 105a, 105b, 105c, 105d of the set of links 105 from node 102a of the set of nodes 102 of the corresponding cell of the set of cells.

In some embodiments, node 102a of the set of nodes 102 of the corresponding cell of the set of cells is configured to send data 130a, 130b, . . . , 130w or 130x of a set of data 130 by one or more links 105a, 105b, 105c, 105d of the set of links 105 to the set of nodes 110, but the one or more humans 106a, 106b, . . . , 106w or 106x of the set of humans 106 is configured to reflect or scatter a corresponding link 105a, 105b, 105c, 105d of the set of links 105, and the corresponding reflected or scattered link 105a, 105b, 105c, 105d of the set of links 105 that is configured to carry the set of user data 130 is delivered to a node 110a of a set of nodes 110 by the corresponding reflected or scattered link 105a, 105b, 105c, 105d of the set of links 105 is received by node 110a of the set of nodes 110.

Other configurations, different types of devices or other number of devices in the set of devices (not shown) are within the scope of the present disclosure.

In some embodiments, at least one of the set of humans 106 or the set of nodes 110 is located in a region 101. In some embodiments, a number of humans in the set of humans 106 in region 101 is also referred to as a number of people or a number of users.

In some embodiments, region 101 includes one or more of a single room, multiple rooms, a shop, a region that includes 3 or more walls, an office or a business location, or the like.

The set of nodes 110 includes at least node 110a.

In some embodiments, the set of nodes 110 includes x nodes, where x is an integer corresponding to a number of nodes in the set of nodes 110.

Each of the nodes 110 corresponds to a device or component that is capable of sending or receiving data.

Each node 110a of the set of nodes 110 includes a set of antennas 109.

Each node 110a of the set of nodes 110 is configured to transmit/receive data with a corresponding set of nodes 102 by each corresponding set of antennas 109a and each corresponding link 105a, 105b, 105c, 105d of a set of links 105.

In some embodiments, one or more nodes in the set of nodes 110 corresponds to one or more of a wireless fidelity (WiFi) node, a wireless router node, a wireless access point, a wireless hub, a wireless switch, a hotspot or the like.

In some embodiments, one or more nodes in the set of nodes 110 corresponds to a user equipment (UE), a computing device, a computing system or a server. In some embodiments, system 1000 (FIG. 10) or device 1100 (FIG. 11) is an embodiment of one or more nodes 110a, 110b, . . . , 110x of the set of nodes 110.

In some embodiments, one or more of the nodes of the set of nodes 110 is a type of mobile terminal, fixed terminal, or portable terminal including a desktop computer, laptop computer, notebook computer, netbook computer, tablet computer, wearable circuitry, mobile handset, server, gaming console, or combinations thereof. In some embodiments, one or more of the devices of the set of nodes 110 comprises a display by which a user interface is displayed. In some embodiments, the set of nodes 110 corresponds to a server farm. In some embodiments, the set of nodes 110 corresponds to a data center.

In some embodiments, one or more nodes 110a of the set of nodes 110 is configured to send or receive data with corresponding node 102a of the set of nodes 102 of the corresponding cell of the set of cells by a corresponding link 105a, 105b, 105c, 105d of the set of links 105.

In some embodiments, the one or more nodes 110a of the set of nodes 110 is configured to send/receive user data 130a, 130b, . . . , 130w or 130x of a set of user data 130 to/from a node 102a of a set of nodes 102 by the corresponding link 105a, 105b, 105c, 105d of the set of links 105.

In some embodiments, the one or more nodes 110a of the set of nodes 110 is configured to send/receive the set of RSRP signals RSRP1 and the set of beam IDs to the set of devices 116 by a network 114.

Other configurations, different types of devices or other number of nodes in the set of nodes 110 are within the scope of the present disclosure.

The set of links includes at least link 105a, 105b, 105c, 105d. In some embodiments, each link of the set of links 105 is configured to electromagnetically couple a corresponding node 102a, of the set of nodes 102 to a set of users (e.g., set of devices 116, etc.).

For ease of illustration, FIG. 1 shows one node (e.g., node 102a), and node 102a is electromagnetically coupled to set of nodes 110 by a corresponding link of the set of links 105. However, in some embodiments, each link of the set of links 105 includes a plurality of links, and the plurality of links are not shown for ease of illustration. Stated differently, while FIG. 1 shows a single link for each link 105a, . . . , 105d of the set of links 105, one or more of 105a, . . . , 105d of the set of links 105 include a plurality of links.

In some embodiments, at least link 105a, 105b, 105c, 105d of the set of links 105 is a wireless link that includes an uplink and a downlink. In some embodiments, at least one or more of link 105a, 105b, 105c, 105d of the set of links 105 is based on technologies, such as code division multiple access (CDMA), wideband CDMA (WCDMA), time division multiple access (TDMA), frequency division multiple access (FDMA), single carrier frequency division multiple access (SC-FDMA), Orthogonal Frequency Division Multiplexing (OFDM), Orthogonal Frequency Division Multiple Access (OFDMA), time division duplexing (TDD), frequency division duplexing (FDD), Bluetooth, Infrared (IR), or the like, or other protocols that may be used in a wireless communications network or a wired data communications network.

Accordingly, the exemplary illustrations provided herein are not intended to limit the embodiments of the disclosure and are merely to aid in the description of aspects of the embodiments of the disclosure.

Other configurations or number of links in at least the set of links 105 are within the scope of the present disclosure.

The set of nodes 110 is coupled to the network 114 by a set of links 103.

The set of links 103 includes at least link 103a. In some embodiments, at least the set of links 103 is a wired link. In some embodiments, at least the set of links 103 is a wireless link. In some embodiments, at least the set of links 103 corresponds to any transmission medium type; e.g. fiber optic cabling, any wired cabling, and any wireless link type(s). In some embodiments, at least the set of links 103 corresponds to shielded, twisted-pair cabling, copper cabling, fiber optic cabling, and/or encrypted data links.

In some embodiments, at least the set of links 103 is based on technologies, such as CDMA, WCDMA, TDMA, FDMA, SC-FDMA, OFDM, OFDMA, TDD, FDD, Bluetooth, IR or the like, or other protocols that may be used in a wireless communications network or a wired data communications network. Accordingly, the exemplary illustrations provided herein are not intended to limit the embodiments of the disclosure and are merely to aid in the description of aspects of the embodiments of the disclosure.

Other configurations or number of links in at least the set of links 103 are within the scope of the present disclosure. For example, while FIG. 1 shows a single link for the set of links 103, but the set of links 103 can include a plurality of links. In some embodiments, the set of links 103 is a single link.

In some embodiments, network 114 corresponds to at least one of a wired or wireless network. In some embodiments, network 114 corresponds to at least one of a radio access network (RAN), a core network, a local area network (LAN), a wide area network (WAN), a metropolitan area network (MAN), an internet area network (IAN), a campus area network (CAN), a virtual private networks (VPN) or combinations thereof. In some embodiments, network 114 corresponds to the Internet.

Other configurations, number of networks or different types of network in at least network 114 are within the scope of the present disclosure.

The set of devices 116 is coupled to the network 114 by a set of links 115.

In some embodiments, at least the set of links 115 is a wired link. In some embodiments, at least the set of links 115 is a wireless link. In some embodiments, at least the set of links 115 corresponds to any transmission medium type; e.g. fiber optic cabling, any wired cabling, and any wireless link type(s). In some embodiments, at least the set of links 115 corresponds to shielded, twisted-pair cabling, copper cabling, fiber optic cabling, and/or encrypted data links.

In some embodiments, at least the set of links 115 is based on technologies, such as CDMA, WCDMA, TDMA, FDMA, SC-FDMA, OFDM, OFDMA, TDD, FDD, Bluetooth, IR or the like, or other protocols that may be used in a wireless communications network or a wired data communications network. Accordingly, the exemplary illustrations provided herein are not intended to limit the embodiments of the disclosure and are merely to aid in the description of aspects of the embodiments of the disclosure.

Other configurations or number of links in at least the set of links 115 are within the scope of the present disclosure. For example, while FIG. 1 shows a single link for the set of links 115, the set of links 115 includes a plurality of links.

The set of devices 116 includes at least a device 116a. In some embodiments, the set of devices 116 includes o devices, where o is an integer corresponding to a number of devices in the set of devices 116.

In some embodiments, one or more devices in the set of devices 116 corresponds to a computing device, a computing system or a server.

In some embodiments, the set of devices 116 includes a system 150 and a database 162.

In some embodiments, system 150 corresponds to a computing device, a computing system or a server. In some embodiments, system 150 is configured to store and execute a crowd counting portion 170.

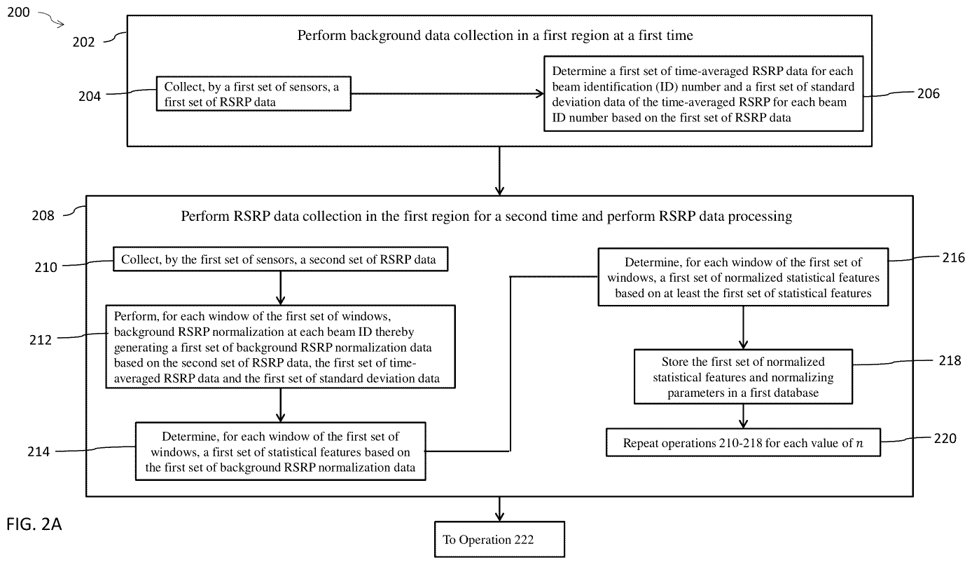

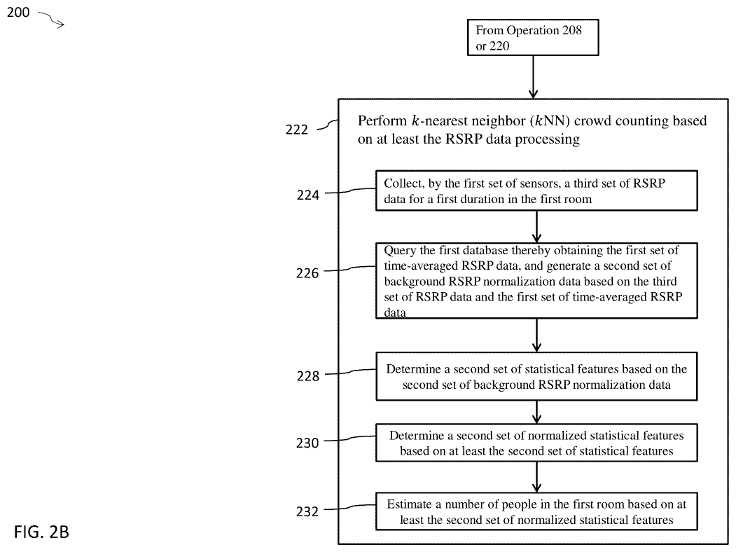

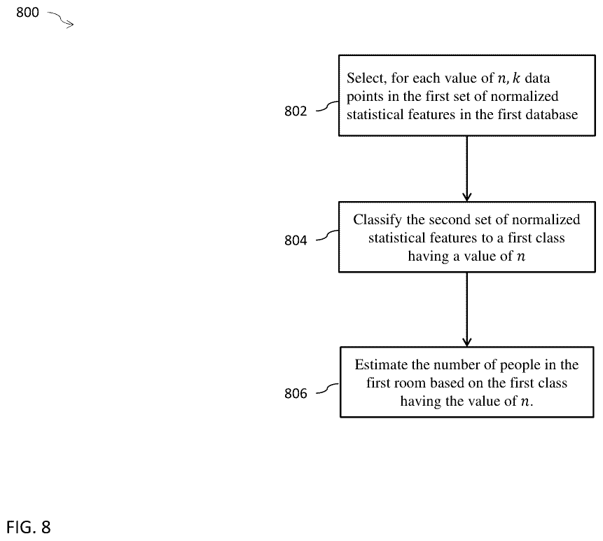

In some embodiments, the crowd counting portion 170 is configured to count a crowd in region 101. In some embodiments, the crowd counting portion 170 is configured to estimate a number of people (e.g., a number of humans in the set of humans 106) in region 101 in accordance with at least method 200 (FIGS. 2A-2B) and method 800 (FIG. 8).

In some embodiments, the database 162 is coupled to the system 150. In some embodiments, the database 162 is configured to store data useable with the crowd counting portion 170. In some embodiments, the data stored in the database 162 is data from at least method 200 (FIGS. 2A-2B) and method 800 (FIG. 8). In some embodiments, the database 162 is referred to as an “RSRP fingerprint database.”

In some embodiments, the system 150 includes a set of servers.

In some embodiments, system 1000 (FIG. 10) or device 1100 (FIG. 11) is an embodiment of one or more devices 116a of the set of devices 116. In some embodiments, system 1000 (FIG. 10) or device 1100 (FIG. 11) is an embodiment of system 150. In some embodiments, the system 150 corresponds to a server farm. In some embodiments, the system 150 corresponds to a data center. In some embodiments, system 1000 (FIG. 10) or device 1100 (FIG. 11) is an embodiment of database 162.

Other configurations, different types of devices or other number of sets in the set of devices 116 are within the scope of the present disclosure.

In some embodiments, system 100 does not include at least one of the set of links 103, the set of links 115, the network 114, and thus the set of devices 116 is directly connected to the set of nodes 110 by a set of links similar to the set of links 103 or the set of links 115, and similar detailed description is omitted.

In some embodiments, the set of nodes 110 and the set of devices 116 are merged into a single system, and thus system 100 does not include at least one of the set of links 103, the set of links 115 and the network 114.

In some embodiments, system 100 is configured to count a crowd in region 101. In some embodiments, system 100 is configured to estimate a number of people (e.g., a number of humans in the set of humans 106) in region 101 in accordance with at least method 200 (FIGS. 2A-2B) and method 800 (FIG. 8).

In some embodiments, system 100 is configured to perform background data collection in region 101. In some embodiments, the background data collection includes at least one of the set of RSRP signals RSRP1 or the set of beam IDs BID. In some embodiments, system 100 is further configured to perform RSRP data collection in the first region for a second time and performing RSRP data processing for database 162. In some embodiments, system 100 is further configured to perform k-nearest neighbor (kNN) crowd counting based on at least the RSRP data processing thereby estimating a number of people in region 101 or counting the crowd in region 101.

In some embodiments, system 100 is configured to estimate a number of people in region 101 or count the crowd in region 101 without the use of one or more cameras.

In some embodiments, system 100 is configured to estimate a number of people in region 101 or count the crowd in region 101 thereby providing security to region 101 without the use of one or more cameras.

In some embodiments, system 100 is configured to estimate a number of people in region 101 or count the crowd in region 101 thereby being able determine if trespassers are present in region 101 without the use of one or more cameras thus enhancing the security of region 101.

In some embodiments, system 100 is configured to estimate a number of people in region 101 or count the crowd in region 101 thereby tracking the locations of the set of humans 106 in region 101 without the use of one or more cameras.

In some embodiments, system 100 is configured to estimate a number of people in region 101 or count the crowd in region 101 thereby determining the flow of people in region 101 without the use of one or more cameras.

Other configurations or number of elements in system 100 are within the scope of the present disclosure.

FIGS. 2A-2B are a flowchart of a method 200, in accordance with some embodiments.

In some embodiments, method 200 is a method of crowd counting. In some embodiments, at least portions of method 200 are performed by at least one or more of elements in system 100.

In some embodiments, at least portions of method 200 are performed by the set of devices 116. In some embodiments, at least portions of method 200 are performed by at least one or more of system 150 or database 162.

In some embodiments, at least portions of method 200 are performed by at least one or more of the set of nodes 110 or the set of devices 116.

In some embodiments, FIGS. 2A-2B are a flowchart of a method of operating system 100 of FIG. 1, and similar detailed description is therefore omitted. It is understood that additional operations may be performed before, during, and/or after the method 200 depicted in FIGS. 2A-2B, and that some other operations may only be briefly described herein. In some embodiments, other order of operations of method 200 is within the scope of the present disclosure. In some embodiments, one or more operations of method 200 are not performed.

Method 200 includes exemplary operations, but the operations are not necessarily performed in the order shown. Operations may be added, replaced, changed order, and/or eliminated as appropriate, in accordance with the spirit and scope of disclosed embodiments. It is understood that method 200 utilizes features of one or more of system 100.

In operation 202 of method 200, background data collection is performed in a first region at a first time T1.

In some embodiments, the first region includes region 101. In some embodiments, the first region does not include any humans at the first time T1.

In some embodiments, the background data collection includes at least one of the set of RSRP signals RSRP1 or the set of beam IDs BID from FIG. 1.

In some embodiments, the background data collection of operation 202 is performed by at least one of the set of nodes 110 or the set of devices 116.

In some embodiments, operation 202 includes at least one of operation 204 or operation 206. In some embodiments, operation 202 further includes storing the background data collection in the first database.

In operation 204 of method 200, a first set of RSRP data is collected by a first set of sensors.

In some embodiments, the first set of RSRP data includes at least one of the set of RSRP signals RSRP1, a set of RSRP signals 301 or a set of RSRP data P_{0,qi}.

In some embodiments, the first set of sensors includes the set of devices 110.

In some embodiments, operation 204 further includes obtaining the set of beam identification numbers BID or q for each RSRP signal in the first set of RSRP data. In some embodiments, operation 204 further includes storing the first set of RSRP data in the first database.

In operation 206 of method 200, a first set of time-averaged RSRP data 321 for each beam ID number is determined based on the first set of RSRP data, and a first set of standard deviation data 323 of the time-averaged RSRP for each beam ID number is determined based on the first set of RSRP data.

In some embodiments, the first set of time-averaged RSRP data 321 for each beam ID number is determined according to equation 1 as:

$${\overline{P}}_{0 , q} = \frac{1}{{N}_{t}} {\sum }_{i = 1}^{{N}_{t}} {P}_{0 , qi} \qquad ( 1 )$$

Where P̅_{0,q} is the first set of time-averaged RSRP data 321 for each beam ID number, q is the beam ID number, T is a total measurement time in operation 204, and Nₜ is a number of measurement samples in the total measurement time T, and P_{0,qi} is the first set of RSRP data collected in operation 204. In some embodiments, the beam ID number is 1 or more.

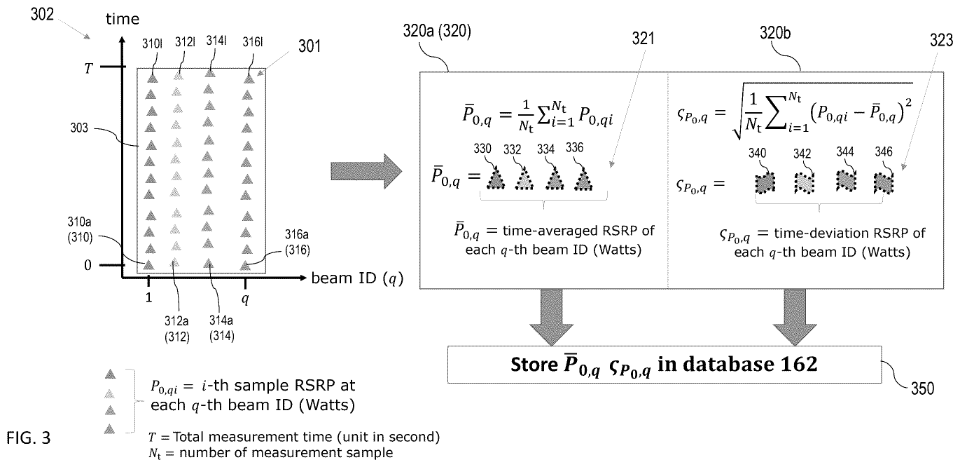

In some embodiments, the total measurement time T has the units of seconds. In some embodiments, the first set of time-averaged RSRP data 321 for each beam ID number has the units of watts. Further details of the first set of time-averaged RSRP data 321 are described in FIG. 3 (described below).

In some embodiments, the first set of standard deviation data 323 of the time-averaged RSRP for each beam ID number is determined according to equation 2 as:

$${ς}_{{P}_{0} , q} = \sqrt{\frac{1}{{N}_{t}} {\sum }_{i = 1}^{{N}_{t}} {( {P}_{0 , qi} - {\overline{P}}_{0 , q} )}^{2}} \qquad ( 2 )$$

Where [symbol] _{P} _{₀}_{,q} is the first set of standard deviation data 323 of the time-averaged RSRP [symbol] for each beam ID number, time in operation 204, and Nₜ is a number of measurement samples in the total measurement time T. Further details of the first set of standard deviation data 323 are described in FIG. 3 (described below). In some embodiments, operation 206 further includes storing the first set of time-averaged RSRP data 321 in the first database.

In some embodiments, operation 208 includes at least one of operation 210, operation 212, operation 214, operation 216, operation 218 or operation 220.

In operation 208 of method 200, RSRP data collection in the first region is performed for a second time T2, and RSRP data processing for a first database is performed.

In some embodiments, the second time T2 is different from the first time T1. In some embodiments, the second time T2 is after the first time T1. In some embodiments, the duration of the first time T1 is the same as the duration of the second time T2. In some embodiments, the duration of the first time T1 is different from the duration of the second time T2.

In some embodiments, the first region includes N humans at the second time, where N is an integer greater than or equal to 0.

In some embodiments, the first database includes at least one of database 162.

In some embodiments, operation 208 further includes storing the RSRP processed data in the first database. In some embodiments, by performing RSRP data processing for the first database of operation 208 results in generated RSRP fingerprinted data that is stored in the first database. In some embodiments, at least the RSRP fingerprinted data is usable to determine or estimate a number of people in the first region. In some embodiments, operation 208 includes one or more steps to train a machine learning model that is useable to determine or estimate a number of people in the first region.

In some embodiments, the RSRP data processing of operation 208 includes one or more steps in training a machine learning model that is useable with the first database thereby generating RSRP fingerprinted data that is stored in the first database.

In operation 210 of method 200, a second set of RSRP data 401 is collected by the first set of sensors.

In some embodiments, the second set of RSRP data 401 includes a set of RSRP data P_{n,qj}.

In some embodiments, operation 210 further includes obtaining the set of beam identification numbers BID or q for each RSRP signal in the second set of RSRP data 401.

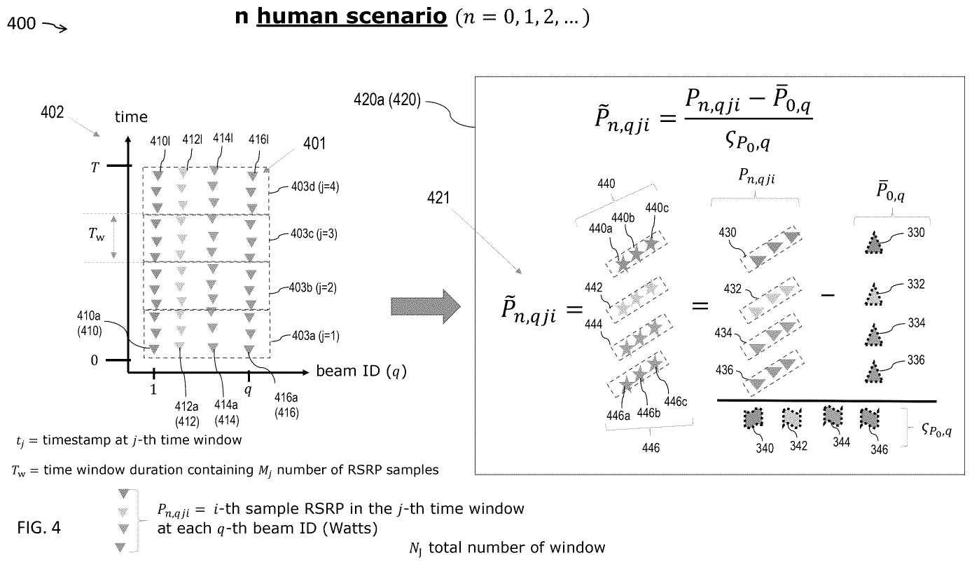

In some embodiments, operation 210 further includes dividing the second set of RSRP data 401 into a first set of windows 403 (as shown in FIG. 4).

In some embodiments, each window 403a, 403b, 403c, 403d of the first set of windows 403 includes a corresponding sub-set of the second set of RSRP data 401.

For example, in some embodiments, window 403a of the first set of windows 403 includes a corresponding first sub-set 410a-410c, 412a-412c, 414a-414c, 416a-416c of the second set of RSRP data 401, and is a corresponding first set of windowed RSRP data. For example, in some embodiments, window 403b of the first set of windows 403 includes a corresponding second sub-set 410d-410f, 412d-412f, 414d-414f, 416d-416f of the second set of RSRP data 401, and is a corresponding second set of windowed RSRP data. For example, in some embodiments, window 403c of the first set of windows 403 includes a corresponding third sub-set 410g-410i, 412g-412i, 414g-414i, 416g-416i of the second set of RSRP data 401, and is a corresponding third set of windowed RSRP data. For example, in some embodiments, window 403d of the first set of windows 403 includes a corresponding third sub-set 410j-4101, 412j-4121, 414j-4141, 416j-4161 of the second set of RSRP data 401, and is a corresponding fourth set of windowed RSRP data.

In operation 212 of method 200, for each window 403a, 403b, 403c, 403d of the first set of windows 403, background RSRP normalization at each beam ID is performed thereby generating a first set of background RSRP normalization data 421 based on the second set of RSRP data 401, the first set of time-averaged RSRP data 321 and the first set of standard deviation data 323.

In some embodiments, the first set of background RSRP normalization data 421 at each beam ID is determined according to equation 3 as:

$${\tilde{P}}_{n , qji} - \frac{{P}_{n , qji} - {\overline{P}}_{0 , q}}{{ς}_{{P}_{o} , q}} \qquad ( 3 )$$

Where P̅_{0,q} is the first set of time-averaged RSRP data 321 for each beam ID number, j is the window number and is an integer ranging from 1 to Nⱼ, q is the beam ID number (starting at 1), [symbol] _{P}_{_{0,q}} is the first set of standard deviation data 323 of the time-averaged RSRP for each beam ID number, and \tilde{P}_{n,qji} is the first set of background RSRP normalization data 421. Further details of the first set of background RSRP normalization data 421 are described in FIG. 4 (described below).

In operation 214 of method 200, for each window 403a, 403b, 403c, 403d of the first set of windows 403, a first set of statistical features 521 is determined based on the first set of background RSRP normalization data 421.

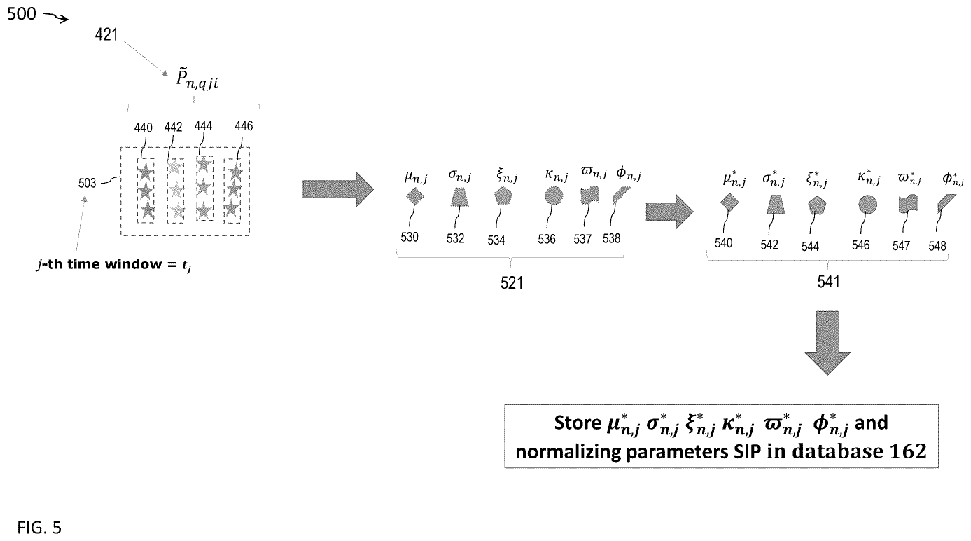

In some embodiments, for each window 403a, 403b, 403c, 403d of the first set of windows 403, the first set of statistical features 521 includes at least one of a first mean μ_{n,j}, a first standard deviation σ_{n,j}, a first skewness ξ_{n,j}, a first kurtosis κ_{n,j}, a first median absolute deviation ω̅_{n,j} or a first average absolute deviation φ_{n,j}. In some embodiments, for each window 403a, 403b, 403c, 403d of the first set of windows, the first mean μ_{n,j} is determined according to equation 4 as:

$${μ}_{n , j} = \frac{1}{{M}_{j} Q} {\sum }_{q = 1}^{Q} {\sum }_{i = 1}^{{M}_{j}} {\tilde{P}}_{n , qji} \qquad ( 4 )$$

Where \tilde{P}_{n,qji} is the first set of background RSRP normalization data 421, q is the beam ID number, and Mⱼ is the number of RSRP samples at a j-th window in the first set of windows 403. Further details of the first set of statistical features 521 are described in FIG. 5 (described below).

In some embodiments, for each window 403a, 403b, 403c, 403d of the first set of windows, the first standard deviation φ_{n,j} is determined according to equation 5 as:

$${σ}_{n , j} = \sqrt{\frac{1}{{M}_{j} Q} {\sum }_{q = 1}^{Q} {\sum }_{i = 1}^{{M}_{j}} {( {\tilde{P}}_{n , qji} - {μ}_{n , j} )}^{2}} \qquad ( 5 )$$

Where \tilde{P}_{n,qji} is the first set of background RSRP normalization data 421, μ_{n,j} is the first mean, q is the beam ID number, and Mⱼ is the number of RSRP samples at a j-th window in the first set of windows 403. Further details of the first set of statistical features 521 are described in FIG. 5 (described below).

In some embodiments, for each window 403a, 403b, 403c, 403d of the first set of windows, the first skewness ξ_{n,j} is determined according to equation 6 as:

$${ξ}_{n , j} = \frac{\frac{1}{{M}_{j} Q} {\sum }_{q = 1}^{Q} {\sum }_{i = 1}^{{M}_{j}} {( {\tilde{P}}_{n , qji} - {μ}_{n , j} )}^{3}}{{σ}_{n , j}^{3}} \qquad ( 6 )$$

Where \tilde{P}_{n,qji} is the first set of background RSRP normalization data 421, ξ_{n,j} is the first skewness, σ_{n,j} is the first standard deviation, μ_{n,j} is the first mean, q is the beam ID number, and Mⱼ is the number of RSRP samples at a j-th window in the first set of windows 403. Further details of the first set of statistical features 521 are described in FIG. 5 (described below).

In some embodiments, for each window 403a, 403b, 403c, 403d of the first set of windows, the first kurtosis κ_{n, j} is determined according to equation 7 as:

$${κ}_{n , j} = \frac{\frac{1}{{M}_{j} Q} {\sum }_{q = 1}^{Q} {\sum }_{i = 1}^{{M}_{j}} {( {\tilde{P}}_{n , qji} - {μ}_{n , j} )}^{4}}{{σ}_{n , j}^{4}} \qquad ( 7 )$$

Where \tilde{P}_{n,qji} is the first set of background RSRP normalization data 421, κ_{n, j} is the first kurtosis, ξ_{n,j} is the first skewness, σ_{n,j} is the first standard deviation, μ_{n,j} is the first mean, q is the beam ID number, and Mⱼ is the number of RSRP samples at a j-th window in the first set of windows 403. Further details of the first set of statistical features 521 are described in FIG. 5 (described below).

In some embodiments, for each window 403a, 403b, 403c, 403d of the first set of windows, the first median absolute deviation ω̅_{n,j} is determined according to equation 8 as:

$${ϖ}_{n , j} = {med}_{iq} ( \vert {\tilde{P}}_{n , qji} - {med}_{iq} \{ {\tilde{P}}_{n , qji} \} \vert ) \qquad ( 8 )$$

Where \tilde{P}_{n,qji} is the first set of background RSRP normalization data 421, ω̅_{n,j} is the first median absolute deviation,

$${med}_{iq} \{ {x}_{iq} \}$$

is the median of x_{iq} among all i and q indices, and q is the beam ID number. Further details of the first set of statistical features 521 are described in FIG. 5 (described below).

In some embodiments, for each window 403a, 403b, 403c, 403d of the first set of windows, the first average absolute deviation φ_{n,j}, is determined according to equation 9 as:

$${ϕ}_{n , j} = \frac{1}{{M}_{j} Q} {\sum }_{q = 1}^{Q} {\sum }_{i = 1}^{{M}_{j}} {\tilde{\vert P}}_{n , qji} - {μ}_{n , j} \vert \qquad ( 9 )$$

Where \tilde{P}_{n,qji} is the first set of background RSRP normalization data 421, φ_{n,j} is the first average absolute deviation, μ_{n,j} is the first mean, q is the beam ID number, and Mⱼ is the number of RSRP samples at a j-th window in the first set of windows 403. Further details of the first set of statistical features 521 are described in FIG. 5 (described below).

In operation 216 of method 200, for each window of the first set of windows, a first set of normalized statistical features 541 is determined based on at least the first set of statistical features 521.

In some embodiments, for each window 403a, 403b, 403c, 403d of the first set of windows 403, the first set of normalized statistical features 541 are determined according to a Z-score method.

In some embodiments, for each window 403a, 403b, 403c, 403d of the first set of windows 403, the first set of normalized statistical features 541 includes at least one of a first normalized mean

$${μ}_{n , j}^{*} ,$$

a first normalized standard deviation

$${σ}_{n , j}^{*} ,$$

a first normalized skewness

$${ξ}_{n , j}^{*} ,$$

and a first normalized kurtosis

$${κ}_{n , j}^{*} ,$$

a first normalized median absolute deviation

$${ϖ}_{n , j}^{*}$$

or a first normalized absolute deviation

$${ϕ}_{n , j}^{*} .$$

In some embodiments, for each window 403a, 403b, 403c, 403d of the first set of windows, the first normalized mean

$${μ}_{n , j}^{*}$$

is determined according to equation 10 as:

$${μ}_{n , j}^{*} = \frac{{μ}_{n , j} - {ρ}_{X 1}}{{ϛ}_{X 1}} \qquad ( 10 )$$

Where ρ_{X1} is a first intermediary mean of the first mean, [symbol] _{X1} is a first intermediary standard deviation of the first mean, μ_{n,j} is the first mean at a j-th window in the first set of windows 403. Further details of the first set of normalized statistical features 541 are described in FIG. 5 (described below).

In some embodiments, the first intermediary mean ρ_{X1} of the first mean μ_{n,j} is determined according to equation 11 as:

$${ρ}_{X 1} = \frac{1}{{N}_{J} {N}_{max}} {\sum }_{n = 1}^{{N}_{max}} {\sum }_{j = 1}^{{N}_{J}} {μ}_{n , j} \qquad ( 11 )$$

Where μ_{n,j} is the first mean, N_{J} is a number of windows in the first set of windows 403, and Nₘₐₓ is a maximum number of known walking humans obtained in the first database.

In some embodiments, the first intermediary standard deviation [symbol] _{X1} of the first mean μ_{n,j} is determined according to equation 12 as:

$${ϛ}_{X 1} = \sqrt{\frac{1}{{N}_{J} {N}_{max}} {\sum }_{n = 1}^{{N}_{max}} {\sum }_{j = 1}^{{N}_{J}} {( {μ}_{n , j} - {ρ}_{X 1} )}^{2}} \qquad ( 12 )$$

Where μ_{n,j} is the first mean, ρ_{X1} is the first intermediary mean of the first mean, Nⱼ is a number of windows in the first set of windows 403, and Nₘₐₓ is the maximum number of known walking humans obtained in the first database.

In some embodiments, for each window 403a, 403b, 403c, 403d of the first set of

windows, the first normalized standard deviation

$${σ}_{n , j}^{*}$$

is determined according to an equation similar to equation 10, and is expressed as equation 13 as:

$${σ}_{n , j}^{*} = \frac{{σ}_{n , j} - {ρ}_{X 2}}{{ς}_{X 2}} \qquad ( 13 )$$

Where ρ_{X2} is a second intermediary mean of the first standard deviation σn,j, [symbol] _{X2} is a second intermediary standard deviation of the first standard deviation on σ_{n,j}σ_{n,j} is the first standard deviation at a j-th window in the first set of windows 403. Further details of the first set of normalized statistical features 541 are described in FIG. 5 (described below).

In some embodiments, the second intermediary mean ρ_{X2} of the first standard deviation σ_{n,j} is determined according to an equation similar to equation 11, and is expressed as equation 14 as:

$${ρ}_{X 2} = \frac{1}{{N}_{J} {N}_{max}} {\sum }_{n = 1}^{{N}_{max}} {\sum }_{j = 1}^{{N}_{J}} {σ}_{n , j} \qquad ( 14 )$$

Where σ_{n,j} is the first standard deviation, N_{J} is a number of windows in the first set of windows 403, and Nₘₐₓ is a maximum number of known walking humans obtained in the first database.

In some embodiments, the second intermediary standard deviation [symbol] _{X2} of the first standard deviation σ_{n,j} is determined according to an equation similar to equation 12, and is expressed as equation 15 as:

$${ϛ}_{X 2} = \sqrt{\frac{1}{{N}_{J} {N}_{max}} {\sum }_{n = 1}^{{N}_{max}} {\sum }_{j = 1}^{{N}_{J}} {( {σ}_{n , j} - {ρ}_{X 2} )}^{2}} \qquad ( 15 )$$

Where σ_{n,j} is the first standard deviation, ρ_{X2} is the second intermediary mean of the first standard deviation σ_{n,j}, N_{J} is a number of windows in the first set of windows 403, and Nₘₐₓ is a maximum number of known walking humans obtained in the first database.

In some embodiments, for each window 403a, 403b, 403c, 403d of the first set of windows, the first normalized skewness

$${ξ}_{n , j}^{*}$$

is determined according to an equation similar to equation 10, and is expressed as equation 16 as:

$${ξ}_{n , j}^{*} = \frac{{ξ}_{n , j} - {ρ}_{X 3}}{{ϛ}_{X 3}} \qquad ( 16 )$$

Where ρ_{X3} is a third intermediary mean of the first skewness ξ_{n,j}, [symbol] _{X3} is a third intermediary standard deviation of the first skewness ξ_{n,j}, ξ_{n,j} is the first skewness at a j-th window in the first set of windows 403. Further details of the first set of normalized statistical features 541 are described in FIG. 5 (described below).

In some embodiments, the third intermediary mean ρ_{X3} of the first skewness ξ_{n,j} is determined according to an equation similar to equation 11, and is expressed as equation 17 as:

$${ρ}_{X 3} = \frac{1}{{N}_{1} {N}_{max}} {\sum }_{n = 1}^{{N}_{max}} {\sum }_{j = 1}^{{N}_{J}} {ξ}_{n , j} \qquad ( 17 )$$

Where ξ_{n,j} is the first skewness, N_{J} is a number of windows in the first set of windows 403, and Nₘₐₓ is a maximum number of known walking humans obtained in the first database.

In some embodiments, the third intermediary standard deviation [symbol] _{X3} of the first skewness ξ_{n,j} is determined according to an equation similar to equation 12, and is expressed as equation 18 as:

$${ϛ}_{X 3} = \sqrt{\frac{1}{{N}_{1} {N}_{max}} {\sum }_{n = 1}^{{N}_{max}} {\sum }_{j = 1}^{{N}_{J}} {( {ξ}_{n , j} - {ρ}_{X 3} )}^{2}} \qquad ( 18 )$$

Where ξ_{n,j} is the first skewness, ρ_{X3} is the third intermediary mean of the first skewness ξ_{n,j}, N_{J} is a number of windows in the first set of windows 403, and Nₘₐₓ is a maximum number of known walking humans obtained in the first database.

In some embodiments, for each window 403a, 403b, 403c, 403d of the first set of windows, the first normalized kurtosis

$${κ}_{n , j}^{*}$$

is determined according to an equation similar to equation 10, and is expressed as equation 19 as:

$${κ}_{n , j}^{*} = \frac{{κ}_{n , j} - {ρ}_{X 4}}{{ϛ}_{X 4}} \qquad ( 19 )$$

Where ρ_{X4} is a fourth intermediary mean of the first kurtosis κ_{n,j}, [symbol] _{X4} is a fourth intermediary standard deviation of the first kurtosis κ_{n,j}, κ_{n, j} is the first kurtosis, and j is a number of windows in the first set of windows 403. Further details of the first set of normalized statistical features 541 are described in FIG. 5 (described below).

In some embodiments, the fourth intermediary mean ρ_{X4} of the first kurtosis κ_{n,j} is determined according to an equation similar to equation 11, and is expressed as equation 20 as:

$${ρ}_{X4} = \frac{1}{{N}_{J} {N}_{max}} {\sum }_{n = 1}^{{N}_{max}} {\sum }_{j = 1}^{{N}_{J}} {κ}_{n , j} \qquad ( 20 )$$

Where κ_{n,j} is the first kurtosis, N_{J} is a number of windows in the first set of windows 403, and Nₘₐₓ is a maximum number of known walking humans obtained in the first database.

In some embodiments, the fourth intermediary standard deviation [symbol] _{X4} of the first kurtosis κ_{n,j} is determined according to an equation similar to equation 12, and is expressed as equation 21 as:

$${ϛ}_{X 4} = \sqrt{\frac{1}{{N}_{J} {N}_{max}} {\sum }_{n = 1}^{{N}_{max}} {\sum }_{j = 1}^{{N}_{J}} {( {κ}_{n , j} - {ρ}_{X 4} )}^{2}} \qquad ( 21 )$$

Where κ_{n,j} is the first kurtosis, ρ_{X4} is the fourth intermediary mean of the first kurtosis κ_{n,j}, N_{J} is a number of windows in the first set of windows 403, and Nₘₐₓ is a maximum number of known walking humans obtained in the first database.

In some embodiments, for each window 403a, 403b, 403c, 403d of the first set of windows, the first normalized median absolute deviation

$${\overline{ω}}_{n , j}^{*}$$

is determined according to an equation similar to equation 10, and is expressed as equation 22 as:

$${\overline{ω}}_{n , j}^{*} = \frac{{\overline{ω}}_{n , j} - {ρ}_{X 5}}{{ϛ}_{X 5}} \qquad ( 22 )$$

Where ρ_{X5} is a fifth intermediary mean of the first median absolute deviation ω̅_{n,j}, [symbol] _{X5} is a fifth intermediary standard deviation of the first median absolute deviation ω̅_{n,j}, ω̅_{n,j} is the first median absolute deviation at a j-th window in the first set of windows 403. Further details of the first set of normalized statistical features 541 are described in FIG. 5 (described below).

In some embodiments, the fifth intermediary mean ρ_{X5} of the first median absolute deviation ω̅_{n,j} is determined according to an equation similar to equation 11, and is expressed as equation 23, as

$${ρ}_{X 5} = \frac{1}{{N}_{J} {N}_{max}} {\sum }_{n = 1}^{{N}_{max}} {\sum }_{j = 1}^{{N}_{J}} {\overline{ω}}_{n , j} \qquad ( 23 )$$

Where ω̅_{n,j} is the first median absolute deviation, N_{J} is a number of windows in the first set of windows 403, and Nₘₐₓ is a maximum number of known walking humans obtained in the first database.

In some embodiments, the fifth intermediary standard deviation [symbol] _{X5} of the first median absolute deviation ω̅_{n,j} is determined according to an equation similar to equation 12, and is expressed as equation 24 as:

$${ϛ}_{X 5} = \sqrt{\frac{1}{{N}_{J} {N}_{max}} {\sum }_{n = 1}^{{N}_{max}} {\sum }_{j = 1}^{{N}_{J}} {( {\overline{ω}}_{n , j} - {ρ}_{X 5} )}^{2}} \qquad ( 24 )$$

Where ω̅_{n,j} is the first median absolute deviation, ρ_{X5} is the fifth intermediary mean of the first median absolute deviation ω_{n,j}, N_{J} is a number of windows in the first set of windows 403, and Nₘₐₓ is a maximum number of known walking humans obtained in the first database.

In some embodiments, for each window 403a, 403b, 403c, 403d of the first set of windows, the first normalized average absolute deviation

$${ϕ}_{n , j}^{*}$$

is determined according to an equation similar to equation 10, and is expressed as equation 25 as:

$${ϕ}_{n , j}^{*} = \frac{{ϕ}_{n , j} - {ρ}_{X 6}}{{ϛ}_{X 6}} \qquad ( 25 )$$

Where ρ_{X6} is a fifth intermediary mean of the first average absolute deviation φ_{n,j}, [symbol] _{X6} is a fifth intermediary standard deviation of the first average absolute deviation φ_{n,j}, φ_{n,j} is the first average absolute deviation at a j-th window in the first set of windows 403. Further details of the first set of normalized statistical features 541 are described in FIG. 5 (described below).

In some embodiments, the fifth intermediary mean ρ_{X6} of the first average absolute deviation φ_{n,j} is determined according to an equation similar to equation 11, and is expressed as equation 26 as:

$${ρ}_{X 6} = \frac{1}{{N}_{J} {N}_{max}} {\sum }_{n = 1}^{{N}_{max}} {\sum }_{j = 1}^{{N}_{J}} {ϕ}_{n , j} \qquad ( 26 )$$

Where φ_{n,j} is the first average absolute deviation, N_{J} is a number of windows in the first set of windows 403, and Nₘₐₓ is a maximum number of known walking humans obtained in the first database.

In some embodiments, the fifth intermediary standard deviation [symbol] _{X6} of the first average absolute deviation φ_{n,j} is determined according to an equation similar to equation 12, and is expressed as equation 27 as:

$${ϛ}_{X 6} = \sqrt{\frac{1}{{N}_{J} {N}_{max}} {\sum }_{n = 1}^{{N}_{max}} {\sum }_{j = 1}^{{N}_{J}} {( {ϕ}_{n , j} - {ρ}_{X 6} )}^{2}} \qquad ( 27 )$$

Where φ_{n,j}, is the first average absolute deviation, ρ_{X6} is the fifth intermediary mean of the first average absolute deviation φ_{n,j}, N_{J} is a number of windows in the first set of windows 403, and Nₘₐₓ is a maximum number of known walking humans obtained in the first database.

In operation 218 of method 200, the first set of normalized statistical features 541 is stored in the first database. In some embodiments, operation 218 further includes storing a set of intermediary parameters SIP in the first database. In some embodiments, the set of intermediary parameters SIP includes one or more of the first intermediary mean ρ_{X1} of the first mean μ_{n,j}, the first intermediary standard deviation [symbol] _{X1} of the first mean μ_{n,j}, ρ_{X2} is a second intermediary mean of the first standard deviation σ_{n,j}, [symbol] _{X2} is a second intermediary standard deviation of the first standard deviation σ_{n,j}, ρ_{X3} is a third intermediary mean of the first skewness ξ_{n,j}, [symbol] _{X3} is a third intermediary standard deviation of the first skewness ξ_{n,j}, Where ρ_{X4} is a fourth intermediary mean of the first kurtosis κ_{n,j}, [symbol] _{X4} is a fourth intermediary standard deviation of the first kurtosis κ_{n,j}, ρ_{X5} is a fifth intermediary mean of the first median absolute deviation ω̅_{n,j}, [symbol] _{X5} is a fifth intermediary standard deviation of the first median absolute deviation ω̅_{n,j}, ρ_{X6} is a fifth intermediary mean of the first average absolute deviation φ_{n,j}, and [symbol] _{X6} is a fifth intermediary standard deviation of the first average absolute deviation φ_{n,j}.

In operation 220 of method 200, at least one or more of operations 210, 212, 214 or 216, 218 are repeated for each value of N−1. For example, in some embodiments, if the value of N is 2, then operations 210, 212, 214, 216 and 218 are performed 2 times; a first time when the value of N is equal to 1, and a second time when the value of N is equal to 2. In some embodiments, in operation 220 of method 200, at least one or more of operations 210, 212, 214, 216 or 218 are performed for each value of N or for each number of humans that are modeled in region 101.

In operation 222 of method 200, kNN crowd counting is performed based on at least the RSRP data processing.

In some embodiments, operation 222 is performed for an unknown number of users in region 101.

In some embodiments, kNN crowd counting is performed based on at least the generated RSRP fingerprinted data that is stored in the first database. In some embodiments, the generated RSRP fingerprinted data that is stored in the first database is data generated by the machine learning model for a number of different user scenarios in region 101.

In some embodiments, operation 222 includes at least one of operation 224, operation 226, operation 228, operation 230 or operation 232.

In operation 224 of method 200, a third set of RSRP data 601 is collected in the first region for a first duration TTw. In some embodiments, the first duration TTw is a duration of the test time window (TTw).

In some embodiments the third set of RSRP data 601 is collected by the first set of sensors 110.

In some embodiments, the third set of RSRP data 601 includes a set of RSRP data

$${P}_{ql}^{′} .$$

In some embodiments, the first duration TTW is the same as at least one of the duration of the first time T1 or the duration of the second time T2. In some embodiments, the first duration TTw is considered as a j-th time window. In some embodiments, the first duration TTw is also referred to as a “measured duration.”

In some embodiments, the first duration TTW is different from at least one of the duration of the first time T1 or the duration of the second time T2.

In some embodiments, operation 224 further includes obtaining the set of beam identification numbers BID or q for each RSRP signal in the third set of RSRP data 601.

In some embodiments, operation 224 further includes dividing the third set of RSRP data 601 into a second set of windows (not labelled).

In some embodiments, dividing the third set of RSRP data 601 into a second set of windows (not labelled) is similar to dividing the second set of RSRP data 401 into the first set of windows 403, and similar detailed description is therefore omitted.

In some embodiments, each window of the second set of windows includes a corresponding sub-set of the second set of RSRP data 601.

In some embodiments, each corresponding sub-set of the second set of RSRP data 601 that is in each corresponding window is similar to each corresponding sub-set of the second set of RSRP data 401 that is in each corresponding window 403a, 403b, 403c, 403d of the first set of windows 403.

In operation 226 of method 200, the first database is queried thereby obtaining the first set of time-averaged RSRP data 321, and a second set of background RSRP normalization data 621 is generated based on the third set of RSRP data 601 and the first set of time-averaged RSRP data 321.

In some embodiments, the second set of background RSRP normalization data 621 at each beam ID is determined according to equation 28 as:

$${\tilde{P}}_{ql}^{′} = \frac{{P}_{ql}^{′} - {\overline{P}}_{0 , q}}{{ϛ}_{{P}_{0} , q}} \qquad ( 28 )$$

Where P̅_{0,q} is the first set of time-averaged RSRP data 321 for each beam ID number, j is the window number, q is the beam ID number, and 1 is an integer that corresponds to a measured RSRP sample index and ranges from l=1,2, . . . , N_{L}, where N_{L} is an integer corresponding to the number of entries in the measured RSRP sample index, and

$${P}_{ql}^{′}$$

is the third set of RSRP data 601, and

$${\tilde{P}}_{ql}^{′}$$

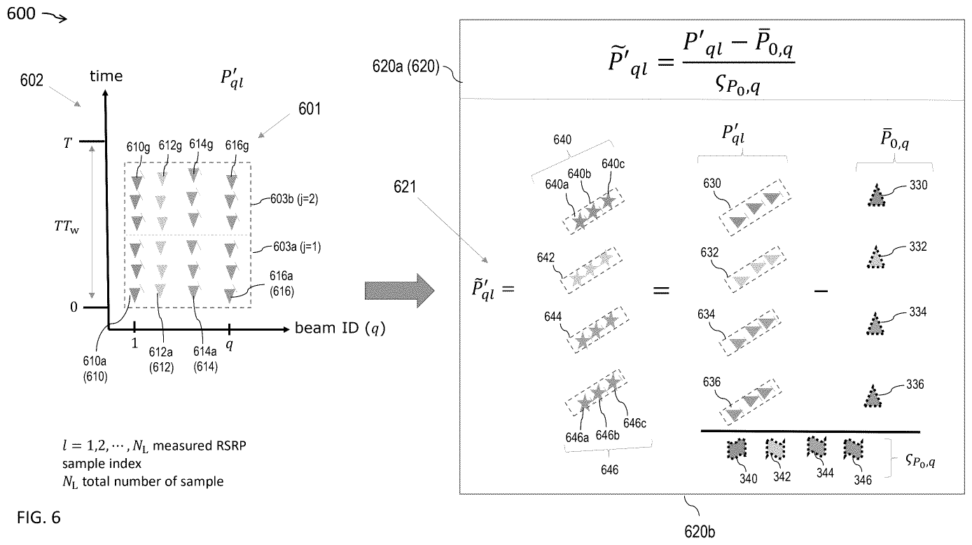

is the second set of background RSRP normalization data 621 at each beam ID. In some embodiments, the integer N_{L} is equal to the integer Nₜ. Further details of the second set of background RSRP normalization data 621 are described in FIG. 6 (described below).

In operation 228 of method 200, a second set of statistical features 721 is determined based on the second set of background RSRP normalization data 621. In some embodiments, operation 228 includes determining the second set of statistical features 721 is determined based on the second set of background RSRP normalization data 621 and the set of intermediary parameters SIP. In some embodiments, operation 228 further comprises loading the set of intermediary parameters SIP from the first database.

In some embodiments, for each window 703a, 703b, 703c, 703d of the second set of windows 703, the second set of statistical features 721 includes at least one of a second mean μⱼ, a second standard deviation σⱼ a second skewness ξⱼ, a second kurtosis κⱼ a second median absolute deviation

$${\overline{ω}}_{j}^{′}$$

or a second average absolute deviation

$${ϕ}_{j}^{′} .$$

In some embodiments, for each window 703a, 703b, 703c, 703d of the second set of windows 703, the second mean

$${μ}_{j}^{′}$$

is determined according to equation 29 as:

$${μ}_{j}^{′} = \frac{1}{{M}_{j} Q} {\sum }_{q = 1}^{Q} {\sum }_{i = 1}^{{M}_{j}} {\tilde{P}}_{ql}^{′} \qquad ( 29 )$$

Where

$${\tilde{P}}_{ql}^{′}$$

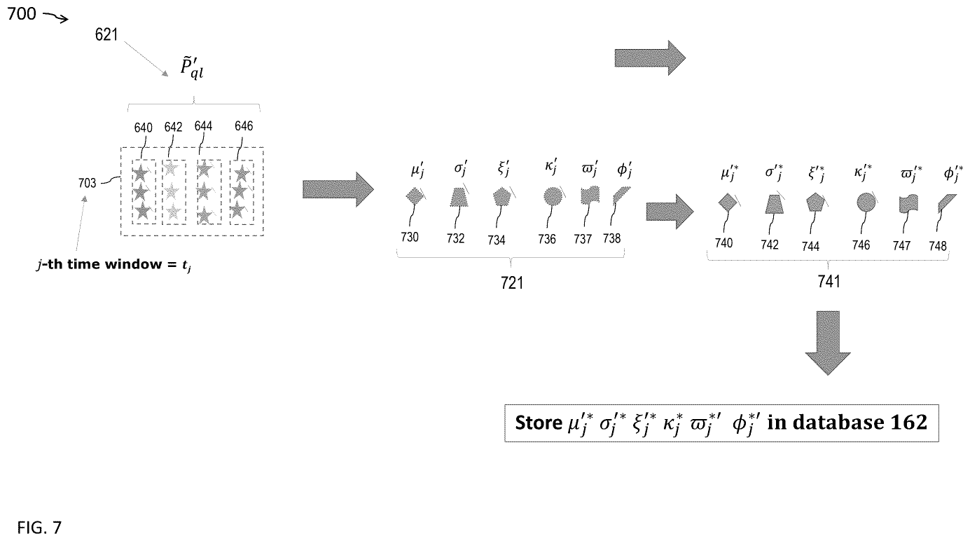

is the second set of background RSRP normalization data 621 at each beam ID, q is the beam ID number, j is the window number and is an integer ranging from 1 to N_{J} in the second set of windows 703, and Mⱼ is the number of RSRP samples at a j-th window in the second set of windows 703. Further details of the second set of statistical features 721 are described in FIG. 7 (described below).

In some embodiments, for each window 703a, 703b, 703c, 703d of the second set of windows, the second standard deviation

$${σ}_{n , j}^{′}$$

is determined according to equation 30 as:

$${σ}_{j}^{′} = \sqrt{\frac{1}{{M}_{j} Q} {\sum }_{q = 1}^{Q} {\sum }_{i = 1}^{{M}_{j}} {( {\tilde{P}}_{ql}^{′} - {μ}_{j}^{′} )}^{2}}$$

Where

$${\tilde{P}}_{ql}^{′}$$

is the second set of background RSRP normalization data 621 at each beam ID,

$${μ}_{j}^{′}$$

is the second mean, q is the beam ID number, and Mⱼ is the number of RSRP samples at a j-th window in the second set of windows 703. Further details of the second set of statistical features 721 are described in FIG. 7 (described below).

In some embodiments, for each window 703a, 703b, 703c, 703d of the second set of windows 703, the second skewness

$${ξ}_{j}^{′}$$

is determined according to equation 31 as:

$${ξ}_{j} = \frac{\frac{1}{{M}_{j} Q} {\sum }_{q = 1}^{Q} {\sum }_{i = 1}^{{M}_{j}} {( {\tilde{P}}_{ql}^{′} - {μ}_{j}^{′} )}^{3}}{{σ}_{j}^{′ 3}} \qquad ( 31 )$$

Where

$${\tilde{P}}_{ql}^{′}$$

is the second set of background RSRP normalization data 621 at each beam ID,

$${μ}_{j}^{′}$$

is the second mean,

$${σ}_{j}^{′}$$

is the second standard deviation, q is the beam ID number, and Mⱼ is the number of RSRP samples at a j-th window in the second set of windows 703. Further details of the second set of statistical features 721 are described in FIG. 7 (described below).

In some embodiments, for each window 703a, 703b, 703c, 703d of the second set of windows 703, the second kurtosis

$${κ}_{j}^{′}$$

is determined according to equation 32 as:

$${κ}_{n , j}^{′} = \frac{\frac{1}{{M}_{j} Q} {\sum }_{q = 1}^{Q} {\sum }_{i = 1}^{{M}_{j}} {( {\tilde{P}}_{ql}^{′} - {μ}_{j}^{′} )}^{4}}{{σ}_{j}^{′ 4}} \qquad ( 32 )$$

Where

$${\tilde{P}}_{ql}^{′}$$

is the second set of background RSRP normalization data 621 at each beam ID,

$${μ}_{j}^{′}$$

is the second mean

$${σ}_{j}^{′}$$

is the second standard deviation, q is the beam ID number, and Mⱼ is the number of RSRP samples at a j-th window in the second set of windows 703. Further details of the second set of statistical features 721 are described in FIG. 7 (described below).

In some embodiments, for each window 703a, 703b, 703c, 703d of the second set of windows 703, the second median absolute deviation ω̅ ′ⱼ is determined according to equation 33 as:

$${{ϖ}^{′}}_{j} = {{med}_{iq}}^{′} ( \vert {{\tilde{P}}^{′}}_{ql} - {{med}_{iq}}^{′} \{ {{\tilde{P}}^{′}}_{ql} \} \vert ) \qquad ( 33 )$$

Where \tilde{P}′_{ql} is the second set of background RSRP normalization data 621 at each beam ID, ω̅ ′ⱼ is the second median absolute deviation,

$${{med}_{iq}}^{′} \{ {x}_{iq} \}$$

is the median of x_{iq} among all i and q indices, and q is the beam ID number. Further details of the second set of statistical features 721 are described in FIG. 7 (described below).

In some embodiments, for each window 703a, 703b, 703c, 703d of the second set of windows 703, the second average absolute deviation φ′ⱼ is determined according to equation 34

$${{ϕ}^{′}}_{j} = \frac{1}{{M}_{j} Q} {\sum }_{q = 1}^{Q} {\sum }_{i = 1}^{{M}_{j}} \vert {{\tilde{P}}^{′}}_{ql} - {μ}_{j} \vert \qquad ( 34 )$$

Where \tilde{P}′_{ql} is the second set of background RSRP normalization data 721, φ′ⱼ is the second average absolute deviation, μ′ⱼ is the second mean, q is the beam ID number, and Mⱼ is the number of RSRP samples at a j-th window in the second set of windows 703. Further details of the second set of statistical features 721 are described in FIG. 7 (described below).

In operation 230 of method 200, a second set of normalized statistical features 741 is determined based on at least the second set of statistical features 721.

In some embodiments, for each window 703a, 703b, 703c, 703d of the second set of windows 703, the second set of normalized statistical features 741 are determined according to a Z-score method.

In some embodiments, for each window 703a, 703b, 703c, 703d of the second set of windows 703, the second set of normalized statistical features 741 includes at least one of a second normalized mean

$${μ}_{j}^{′ *} ,$$

a second normalized standard deviation

$${{σ}^{′}}_{j}^{*} ,$$

a second normalized skewness

$${{ξ}^{′}}_{j}^{*} ,$$

a second normalized kurtosis

$${κ}_{j}^{′ *}$$

a second normalized median absolute deviation

$${ϖ}_{j}^{′ *}$$

or a second normalized average absolute deviation

$${ϕ}_{j}^{′ *} .$$

In some embodiments, for each window 703a, 703b, 703c, 703d of the second set of windows 703, the second normalized mean

$${{μ}^{′}}_{j}^{*}$$

is determined according to equation 35 as:

$${{μ}^{′}}_{j}^{*} = \frac{{μ}_{j}^{′} - {ρ}_{X 1}}{{ϛ}_{X 1}} \qquad ( 35 )$$

Where ρ_{X1} is the first intermediary mean of the first mean, [symbol] _{X1} is the first intermediary standard deviation of the first mean

$${μ}_{j}^{′}$$

is the second mean at a j-th window in the second set of windows 703. Further details of the second set of normalized statistical features 741 are described in FIG. 7 (described below).

In some embodiments, for each window 703a, 703b, 703c, 703d of the second set of windows 703, the second normalized standard deviation

$${{σ}^{′}}_{j}^{*}$$

is determined according to an equation similar to equation 13, and is expressed as equation 36 as:

$${σ}_{j}^{′ *} = \frac{{σ}_{j}^{′} - {ρ}_{X 2}}{{ς}_{X 2}} \qquad ( 35 )$$

Where ρ_{X2} is the second intermediary mean, [symbol] _{X2} is the second intermediary standard deviation,

$${σ}_{j}^{′}$$

is the second standard deviation at a j-th window in the second set of windows 703.

Further details of the second set of normalized statistical features 741 are described in FIG. 7 (described below).

In some embodiments, for each window 703a, 703b, 703c, 703d of the second set of windows 703, the second normalized skewness

$${ξ}_{j}^{′ *}$$

is determined according to an equation similar to equation 16, and is expressed as equation 37 as:

$${ξ}_{j}^{′ *} = \frac{{ξ}_{j}^{′} - {ρ}_{X 3}}{{ς}_{X 3}} \qquad ( 37 )$$

Where ρ_{X3} is the third intermediary mean, [symbol] _{X3} is the third intermediary standard deviation, Ξ′ⱼ is the second skewness at a j-th window in the second set of windows 703. Further details of the second set of normalized statistical features 741 are described in FIG. 7 (described below).

In some embodiments, for each window 703a, 703b, 703c, 703d of the second set of windows 703, the second normalized kurtosis

$${κ}_{j}^{′ *}$$

is determined according to an equation similar to equation 19, and is expressed as equation 38 as:

$${κ}_{j}^{′ *} = \frac{{κ}_{j}^{′} - {ρ}_{X 4}}{{ς}_{X 4}} \qquad ( 38 )$$

Where ρ_{X4} is the fourth intermediary mean, [symbol] _{X4} is the fourth intermediary standard deviation, κ′ⱼ is the second kurtosis at a j-th window in the second set of windows 703. Further details of the second set of normalized statistical features 741 are described in FIG. 7 (described below).

In some embodiments, for each window 703a, 703b, 703c, 703d of the second set of windows, the second normalized median absolute deviation

$${\overline{ω}}_{j}^{′ *}$$

is determined according to an equation similar to equation 22, and is expressed as equation 39 as:

$${ϖ}_{j}^{′ *} = \frac{{ϖ}_{j}^{′} - {ρ}_{X 5}}{{ς}_{X 5}} \qquad ( 39 )$$

Where ρ_{X5} is the fifth intermediary mean, [symbol] _{X5} is the fifth intermediary standard deviation,

$${ϖ}_{j}^{′}$$

is the second median absolute deviation at a j-th window in the second set of windows 703. Further details of the first set of normalized statistical features 741 are described in FIG. 7 (described below).

In some embodiments, for each window 703a, 703b, 703c, 703d of the second set of windows, the second normalized average absolute deviation

$${ϕ}_{j}^{′ *}$$

is determined according to an equation similar to equation 25, and is expressed as equation 40 as:

$${ϕ}_{j}^{′ *} = \frac{{ϕ}_{j}^{′} - {ρ}_{X 6}}{{ς}_{X 6}} \qquad ( 40 )$$

Where ρ_{X6} is the fifth intermediary mean, [symbol] _{X6} is the fifth intermediary standard deviation,

$${ϕ}_{j}^{′}$$

is the second average absolute deviation at a j-th window in the second set of windows 703. Further details of the first set of normalized statistical features 741 are described in FIG. 7 (described below).

In some embodiments, operation 230 further comprises storing the second set of normalized statistical features 741 in the first database.

In operation 232 of method 200, a number of people in the first region is estimated based on at least the second set of normalized statistical features 741.

In some embodiments, operation 232 further includes performing kNN crowd counting based on at least the second set of normalized statistical features 741.

In some embodiments, one or more of the operations of method 200 is not performed.

In some embodiments, by using method 200, method 200 is configured to estimate a number of people in region 101 or count the crowd in region 101 without the use of one or more cameras.

In some embodiments, by using method 200, method 200 is configured to estimate a number of people in region 101 or count the crowd in region 101 thereby providing security to region 101 without the use of one or more cameras.

In some embodiments, by using method 200, method 200 is configured to estimate a number of people in region 101 or count the crowd in region 101 thereby being able determine if trespassers are present in region 101 without the use of one or more cameras thus enhancing the security of region 101.

In some embodiments, by using method 200, method 200 is configured to estimate a number of people in region 101 or count the crowd in region 101 thereby tracking the locations of the set of humans 106 in region 101 without the use of one or more cameras.

In some embodiments, by using method 200, method 200 is configured to estimate a number of people in region 101 or count the crowd in region 101 thereby determining the flow of people in region 101 without the use of one or more cameras.

FIG. 3 is an exemplary diagram 300 that illustrates operations 204 and 206 of method 200, in accordance with some embodiments.

In some embodiments, diagram 300 illustrates operation 202 of method 200.

Diagram 300 includes regions 302, 320 and 350.

In some embodiments, region 302 illustrates operation 202 of method 200.

In some embodiments, region 320 illustrates operation 204 of method 200.

Region 302 is a graph of the set of RSRP signals 301 with respect to the time T. The graph of region 302 includes an X-axis and a Y-axis. In some embodiments, the X-axis is the beam ID q, and the Y-axis is the time T.

In some embodiments, region 302 includes a windowed region 303 that includes the set of RSRP signals 301 collected by the first set of sensors over time T.

In some embodiments, region 302 includes the RSRP data collected by the first set of sensors when no human (e.g., n=0) is present in the first region 101, and includes at least the set of RSRP signals 301. In some embodiments, region 302 includes at least one of the set of RSRP signals RSRP1 or the set of RSRP data P_{0,qi}.

In some embodiments, time T is the total measurement time (seconds) for the set of RSRP signals 301. In some embodiments, Nₜ is the number of measurement samples in the set of RSRP signals 310, 312, 314 or 316.

In some embodiments, region 302 is the set of RSRP signals 301 after operation 204.

The set of RSRP signals 301 includes a set of RSRP signals 310, 312, 314 and 316.

The set of RSRP signals 310 corresponds to the collected RSRP signals when the beam ID q is 1.

The set of RSRP signals 310 includes RSRP signals 310a, 310b, . . . , 310l.

The set of RSRP signals 312 corresponds to the collected RSRP signals when the beam ID q is 1.

The set of RSRP signals 312 includes RSRP signals 312a, 312b, . . . , 312l.

The set of RSRP signals 314 corresponds to the collected RSRP signals when the beam ID q is 2.

The set of RSRP signals 314 includes RSRP signals 314a, 314b, . . . , 314l.

The set of RSRP signals 316 corresponds to the collected RSRP signals when the beam ID q is 4.

The set of RSRP signals 316 includes RSRP signals 316a, 316b, . . . , 316l.

In the nonlimiting example shown in FIG. 4, the number of measurement samples Nₜ is equal to integer 1, and the maximum beam ID q is equal to 4. Other values for at least one of the set of RSRP signals 310, 312, 314 or 316 or the beam ID q is within the scope of the present disclosure.

In some embodiments, region 320 illustrates operation 206 of method 200.

Region 320 includes a region 320a and a region 320b.

Region 320a includes equation 1 which is useable to determine the set of RSRP data P_{0,qi} for each beam ID number.

In some embodiments, region 320a is useable to determine the first set of time-averaged RSRP data 321 for each beam ID number based on equation 1.

In some embodiments, region 320a is a non-limiting example of equation 1 in generating the first set of time-averaged RSRP data 321 for each beam ID number.

In some embodiments, the first set of time-averaged RSRP data 321 includes a sub-set of time-averaged RSRP data 330, a sub-set of time-averaged RSRP data 332, a sub-set of time-averaged RSRP data 334 and a sub-set of time-averaged RSRP data 336.

In some embodiments, the sub-set of time-averaged RSRP data 330 is the time-averaged RSRP data determined by equation 1 for the set of RSRP signals 310.

In some embodiments, the sub-set of time-averaged RSRP data 332 is the time-averaged RSRP data determined by equation 1 for the set of RSRP signals 312.

In some embodiments, the sub-set of time-averaged RSRP data 334 is the time-averaged RSRP data determined by equation 1 for the set of RSRP signals 314.

In some embodiments, the sub-set of time-averaged RSRP data 336 is the time-averaged RSRP data determined by equation 1 for the set of RSRP signals 316.

Region 320b includes equation 2 which is useable to determine the first set of standard deviation data [symbol] _{P}_{_{0,q}} of the time-averaged RSRP P_{0,qi} for each beam ID number.

In some embodiments, region 320b is useable to determine the first set of standard deviation data 323 of the time-averaged RSRP for each beam ID number based on equation 2.

In some embodiments, region 320b is a non-limiting example of equation 2 in generating the first set of standard deviation data 323 of the time-averaged RSRP for each beam ID number.

In some embodiments, the first set of standard deviation data 323 includes a sub-set of standard deviation data 340, a sub-set of standard deviation data 342, a sub-set of standard deviation data 344 and a sub-set of standard deviation data 346.

In some embodiments, the sub-set of standard deviation data 340 is the standard deviation data determined by equation 2 for the sub-set of time-averaged RSRP data 330 and the set of RSRP signals 310.

In some embodiments, the sub-set of standard deviation data 342 is the standard deviation data determined by equation 2 for the sub-set of time-averaged RSRP data 332 and the set of RSRP signals 312.

In some embodiments, the sub-set of standard deviation data 344 is the standard deviation data determined by equation 2 for the sub-set of time-averaged RSRP data 334 and the set of RSRP signals 314.

In some embodiments, the sub-set of standard deviation data 346 is the standard deviation data determined by equation 2 for the sub-set of time-averaged RSRP data 336 and the set of RSRP signals 316.

In the nonlimiting example shown in FIG. 4, region 350 illustrates one or more operations to store the set of RSRP data P_{0,qi} for each beam ID number and the first set of standard deviation data [symbol] _{P}_{_{0,q}} of the time-averaged RSRP P_{0,qi} for each beam ID number in the first database 162

Other configurations of diagram 300 are within the scope of the present disclosure.

FIG. 4 is an exemplary diagram 400 that illustrates operations 210 and 212 of method 200, in accordance with some embodiments.

In some embodiments, diagram 400 illustrates portions of operation 208 of method 200.

Diagram 400 includes regions 402 and 420.

In some embodiments, region 402 illustrates operation 210 of method 200.

In some embodiments, region 420 illustrates operation 212 of method 200.

In some embodiments, the second set of RSRP data 401 includes a set of RSRP data P_{n,qj}.

Region 402 is a graph of the second set of RSRP data 401 with respect to the time T.

The graph of region 402 includes an X-axis and a Y-axis. In some embodiments, the X-axis is the beam ID q, and the Y-axis is the time T.

In some embodiments, region 402 includes a windowed region 403 that includes the second set of RSRP data 401 collected by the first set of sensors over time T.

In some embodiments, region 402 includes the RSRP data collected by the first set of sensors when a human (e.g., n=1) is present in the first region 101, and includes at least the second set of RSRP data 401. In some embodiments, region 402 includes at least the set of RSRP data P_{n,qj}.

In some embodiments, windowed region 403 is divided into N_{J} windows 403a, 403b, 403c and 403d, where N_{J} is the total number of windows.

In some embodiments, each window 403a, 403b, 403c, 403d has a corresponding index j, where j is an integer with a value from 1, 2, . . . , N_{J}.

In some embodiments, an index of RSRP samples in the j-th window is equal to i, where i is an integer with a value of 1, 2, . . . , M_{J}.

In some embodiments, each window 403a, 403b, 403c, 403d has a time window duration Tw containing Mⱼ number of samples.

In some embodiments, time T is the total measurement time (seconds) for the second set of RSRP data 401. In some embodiments, Mⱼ is the total number of samples in each window 403a, 403b, 403c, 403d for the set of RSRP signals 410, 412, 414 or 416.

In some embodiments, region 402 is the second set of RSRP data 401 after operation 210.

The second set of RSRP data 401 includes a set of RSRP signals 410, 412, 414 and 416.

The set of RSRP signals 410 corresponds to the collected RSRP signals when the beam ID q is 1.

The set of RSRP signals 410 includes RSRP signals 410a, 410b, . . . , 410l.

The set of RSRP signals 412 corresponds to the collected RSRP signals when the beam ID q is 1.

The set of RSRP signals 412 includes RSRP signals 412a, 412b, . . . , 412l.

The set of RSRP signals 414 corresponds to the collected RSRP signals when the beam ID q is 2.

The set of RSRP signals 414 includes RSRP signals 414a, 414b, . . . , 414l.

The set of RSRP signals 416 corresponds to the collected RSRP signals when the beam ID q is 4.

The set of RSRP signals 416 includes RSRP signals 416a, 416b, . . . , 416l.

In the nonlimiting example shown in FIG. 4, the number of windows N_{J} is equal to 4, each j-th window has 3 measurement samples Mⱼ for each q-th beam, and the maximum beam ID q is equal to 4. Other values for at least one of the set of RSRP signals 410, 412, 414 or 416 or the beam ID q is within the scope of the present disclosure.

In the nonlimiting example shown in FIG. 4, the number of windows is 4, and the integer N_{J} is equal to 4.

In the nonlimiting example shown in FIG. 4, in some embodiments, window 403a of the first set of windows 403 includes a corresponding first sub-set 410a-410c, 412a-412c, 414a-414c, 416a-416c of the second set of RSRP data 401, and is a corresponding first set of windowed RSRP data 403a.

In the nonlimiting example shown in FIG. 4, in some embodiments, window 403b of the first set of windows 403 includes a corresponding second sub-set 410d-410f, 412d-412f, 414d-414f, 416d-416f of the second set of RSRP data 401, and is a corresponding second set of windowed RSRP data 403b.

In the nonlimiting example shown in FIG. 4, in some embodiments, window 403c of the first set of windows 403 includes a corresponding third sub-set 410g-410i, 412g-412i, 414g-414i, 416g-416i of the second set of RSRP data 401, and is a corresponding third set of windowed RSRP data 403c.

In the nonlimiting example shown in FIG. 4, in some embodiments, window 403d of the first set of windows 403 includes a corresponding third sub-set 410j-4101, 412j-4121, 414j-4141, 416j-4161 of the second set of RSRP data 401, and is a corresponding fourth set of windowed RSRP data 403d.

In some embodiments, region 420 illustrates operation 212 of method 200.

In some embodiments, region 420a is the first set of background RSRP normalization data \tilde{P}_{n,qji} for each beam ID number after operation 212.

Region 420 includes a region 420a.

Region 420a includes equation 3 which is useable to determine the first set of background RSRP normalization data \tilde{P}_{n,qji} for each beam ID number.

In some embodiments, region 420a is useable to determine the first set of background RSRP normalization data 421 at each beam ID number based on equation 3.

In some embodiments, region 420a is a non-limiting example of equation 3 in generating the first set of background RSRP normalization data 421 at each beam ID number based on the second set of RSRP data 401 (e.g., the set of RSRP signals 410, 412, 414 or 416), the first set of time-averaged RSRP data 321 (e.g., the sub-set of time-averaged RSRP data 330, 332, 334, 336) and the first set of standard deviation data 323 of the time-averaged RSRP (e.g., the sub-set of standard deviation data 340, 342, 344, 346).

In some embodiments, the first set of background RSRP normalization data 421 at each beam ID number includes a sub-set of background RSRP normalization data 440, a sub-set of background RSRP normalization data 442, a sub-set of background RSRP normalization data 444 and a sub-set of background RSRP normalization data 446.

In some embodiments, the set of RSRP signals 410, 412, 414 or 416 includes the corresponding set of RSRP signals 430, 432, 434 or 436.

In some embodiments, the sub-set of background RSRP normalization data 440 is the background RSRP normalization data determined by equation 3 for the set of RSRP signals 430, the sub-set of time-averaged RSRP data 330 and the sub-set of standard deviation data 340.

In some embodiments, the sub-set of background RSRP normalization data 442 is the background RSRP normalization data determined by equation 3 for the set of RSRP signals 432, the sub-set of time-averaged RSRP data 332 and the sub-set of standard deviation data 342.

In some embodiments, the sub-set of background RSRP normalization data 444 is the background RSRP normalization data determined by equation 3 for the set of RSRP signals 434, the sub-set of time-averaged RSRP data 334 and the sub-set of standard deviation data 344.

In some embodiments, the sub-set of background RSRP normalization data 446 is the background RSRP normalization data determined by equation 3 for the set of RSRP signals 436, the sub-set of time-averaged RSRP data 336 and the sub-set of standard deviation data 346.

Other configurations of diagram 400 are within the scope of the present disclosure.

FIG. 5 is an exemplary diagram 500 that illustrates operations 214, 216 and 218 of method 200, in accordance with some embodiments.

Diagram 500 includes a region 503, the first set of statistical features 521 and the first set of normalized statistical features 541.

In some embodiments, region 503 illustrates the first set of background RSRP normalization data 421 prior to operation 214 of method 200.

In some embodiments, the first set of statistical features 521 is generated after execution of operation 214 of method 200.

In some embodiments, the first set of normalized statistical features 541 is generated after execution of operation 216 of method 200.

In some embodiments, region 503 is a portion of the first set of background RSRP normalization data 421 from FIG. 4. In some embodiments, region 503 is a j-th time window portion of the first set of background RSRP normalization data 421 from FIG. 4.

In some embodiments, for region 503, the first set of statistical features 521 includes at least one of a first mean μ_{n,j}, a first standard deviation σ_{n,j}, a first skewness ξ_{n,j}, a first kurtosis κ_{n, j}, a first median absolute deviation ω̅_{n,j} or a first average absolute deviation φ_{n,j}.

In some embodiments, for region 503, the first set of normalized statistical features 541 includes at least one of a first normalized mean

$${μ}_{n , j}^{*} ,$$

a first normalized standard deviation

$${σ}_{n , j}^{*} ,$$

a first normalized skewness

$${ξ}_{n , j}^{*} ,$$

a first normalized kurtosis

$${κ}_{n , j}^{*} ,$$

a first normalized median absolute deviation

$${\overline{ω}}_{n , j}^{*}$$

or a first normalized absolute deviation

$${ϕ}_{n , j}^{*} .$$

In operation 218 of method 200, the first set of normalized statistical features 541 and the set of normalized features SIP are stored in the first database and are shown as region 550 in FIG. 5.

Other configurations of diagram 500 are within the scope of the present disclosure.

FIG. 6 is an exemplary diagram 600 that illustrates operations 224 and 226 of method 200, in accordance with some embodiments.

In some embodiments, diagram 600 illustrates portions of operation 222 of method 200.

Diagram 600 includes regions 602 and 620.

In some embodiments, region 602 illustrates operation 224 of method 200.

In some embodiments, region 620 illustrates operation 226 of method 200.

In some embodiments, the third set of RSRP data 601 includes a set of RSRP data

$${P}_{ql}^{′}$$

Region 602 is a graph of the third set of RSRP data 601 with respect to the time T.

The graph of region 602 includes an X-axis and a Y-axis. In some embodiments, the X-axis is the beam ID q, and the Y-axis is the time T.

In some embodiments, integer l=1,2, . . . , N_{L} is the measured RSRP sample index.

In some embodiments, integer N_{L} is the total number of samples.

In some embodiments, region 602 includes a windowed region 603 that includes the third set of RSRP data 601 collected by the first set of sensors over time T.

In some embodiments, region 602 includes the RSRP data collected by the first set of sensors when an unknown number of humans is present in the first region 101, and includes at least the third set of RSRP data 601. In some embodiments, region 602 includes at least the set of RSRP data

$${P}_{ql}^{′} .$$

In some embodiments, windowed region 603 is divided into Nj windows 603a, 603b, where Nj is the total number of windows.

In some embodiments, each window 603a, 603b has a corresponding index j, where j is an integer with a value from 1, 2, . . . , N_{J}.

In some embodiments, an index of RSRP samples in the j-th window is equal to i, where i is an integer with a value of 1, 2, . . . , M_{J}.

In some embodiments, each window 603a, 603b has a time window duration Tw containing Mⱼ number of samples. In some embodiments, integer N_{L} is equal to the Mi number of samples.

In some embodiments, time T is the total measurement time (seconds) for the third set of RSRP data 601. In some embodiments, Mⱼ is the total number of samples in each window 603a, 603b for the set of RSRP signals 610, 612, 614 or 616.

In some embodiments, region 602 is the third set of RSRP data 601 after operation 224.

The third set of RSRP data 601 includes a set of RSRP signals 610, 612, 614 and 616.

The set of RSRP signals 610 corresponds to the collected RSRP signals when the beam ID q is 1.

The set of RSRP signals 610 includes RSRP signals 610a, 610b, . . . , 610f.

The set of RSRP signals 612 corresponds to the collected RSRP signals when the beam ID q is 2.

The set of RSRP signals 612 includes RSRP signals 612a, 612b, . . . , 612f.

The set of RSRP signals 614 corresponds to the collected RSRP signals when the beam ID q is 3.

The set of RSRP signals 614 includes RSRP signals 614a, 614b, . . . , 614f.

The set of RSRP signals 616 corresponds to the collected RSRP signals when the beam ID q is 4.

The set of RSRP signals 616 includes RSRP signals 616a, 616b, . . . , 616f.

In the nonlimiting example shown in FIG. 6, the number of measurement samples Nₜ is equal to integer f, and the maximum beam ID q is equal to 4. Other values for at least one of the set of RSRP signals 610, 612, 614 or 616 or the beam ID q is within the scope of the present disclosure.

In the nonlimiting example shown in FIG. 6, the number of windows is 2, and the integer N_{J} is equal to 2.

In the nonlimiting example shown in FIG. 6, in some embodiments, window 603a of the first set of windows 603 includes a corresponding first sub-set 610a-610c, 612a-612c, 614a-614c, 616a-616c of the third set of RSRP data 601, and is a corresponding first set of windowed RSRP data 603a.

In the nonlimiting example shown in FIG. 6, in some embodiments, window 603b of the first set of windows 603 includes a corresponding second sub-set 610d-610f, 612d-612f, 614d-614f, 616d-616f of the third set of RSRP data 601, and is a corresponding second set of windowed RSRP data 603b.

In some embodiments, region 620 illustrates operation 226 of method 200.

In some embodiments, region 620a is the first set of background RSRP normalization data \tilde{P}_{n,qji} for each beam ID number after operation 226.

Region 620 includes a region 620a.

Region 620a includes equation 28 which is useable to determine the second set of background RSRP normalization data

$${\tilde{P}}_{ql}^{′}$$

at each beam ID number.

In some embodiments, region 620a is useable to determine the second set of background RSRP normalization data 621 at each beam ID number based on equation 28.

In some embodiments, region 620a is a non-limiting example of equation 28 in generating the second set of background RSRP normalization data 621 at each beam ID number based on the third set of RSRP data 601 (e.g., the set of RSRP signals 610, 612, 614 or 616) and the first set of time-averaged RSRP data 321 (e.g., the sub-set of time-averaged RSRP data 330, 332, 334, 336).

In some embodiments, the second set of background RSRP normalization data 621 at each beam ID number includes a sub-set of RSRP data 640, a sub-set of RSRP data 642, a sub-set of RSRP data 644 and a sub-set of RSRP data 646.

In some embodiments, the set of RSRP signals 610, 612, 614 or 616 includes the corresponding set of RSRP signals 630, 632, 634 or 636.

In some embodiments, the sub-set of RSRP data 640 is the RSRP data determined by equation 28 for the set of RSRP signals 630, the sub-set of time-averaged RSRP data 330 and the sub-set of standard deviation data 340.

In some embodiments, the sub-set of RSRP data 642 is the RSRP data determined by equation 28 for the set of RSRP signals 632, the sub-set of time-averaged RSRP data 332 and the sub-set of standard deviation data 342.

In some embodiments, the sub-set of RSRP data 644 is the RSRP data determined by equation 28 for the set of RSRP signals 634, the sub-set of time-averaged RSRP data 334 and the sub-set of standard deviation data 344.

In some embodiments, the sub-set of RSRP data 646 is the RSRP data determined by equation 28 for the set of RSRP signals 636, the sub-set of time-averaged RSRP data 336 and the sub-set of standard deviation data 346.

Other configurations of diagram 600 are within the scope of the present disclosure.

FIG. 7 is an exemplary diagram 700 that illustrates operations 228 and 230 of method 200, in accordance with some embodiments.

Diagram 700 includes a region 703, the second set of statistical features 721 and the second set of normalized statistical features 741.

In some embodiments, region 703 illustrates the second set of background RSRP normalization data 621 prior to operation 228 of method 200.

In some embodiments, the second set of statistical features 721 is generated after execution of operation 228 of method 200.

In some embodiments, the second set of normalized statistical features 741 is generated after execution of operation 230 of method 200.

In some embodiments, region 703 is a portion of the second set of background RSRP normalization data 621 from FIG. 6. In some embodiments, region 703 is a j-th time window portion of the second set of background RSRP normalization data 621 from FIG. 6.

In some embodiments, for region 703, the second set of statistical features 721 includes at least one of a second mean μ′ⱼ, a second standard deviation σ′ⱼ, a second skewness ξ′ⱼ a second kurtosis κ′ⱼ, a second median absolute deviation

$${\overline{ω}}_{j}^{′}$$

or a second average absolute deviation

$${ϕ}_{j}^{′} .$$

In some embodiments, for region 703, the second set of normalized statistical features 741 includes at least one of a second normalized mean

$${μ}_{j}^{′ *} ,$$

a second normalized standard deviation

$${σ}_{j}^{′ *} ,$$

a second normalized skewness

$${ξ}_{j}^{′ *} ,$$

a second normalized kurtosis

$${κ}_{j}^{′ *} ,$$

a second normalized median absolute deviation

$${\overline{ω}}_{j}^{′ *}$$

or a second normalized average absolute deviation

$${ϕ}_{j}^{′ *} .$$

Other configurations of diagram 700 are within the scope of the present disclosure.

FIG. 8 is a flowchart of a method 800, in accordance with some embodiments.

Method 800 is an embodiment of at least operation 232 of method 200 of FIGS. 2A-2B, and similar detailed description is therefore omitted. For example, in some embodiments, method 800 is a method of at least estimating a number of people in the first region based on at least the second set of normalized statistical features 741. In some embodiments, method 800 is a method of at least performing kNN crowd counting based on at least the second set of normalized statistical features 741.

In some embodiments, method 800 is a kNN crowd counting algorithm.

In some embodiments, method 800 is a method of crowd counting. In some embodiments, at least portions of method 800 are performed by at least one or more of elements in system 100.

In some embodiments, at least portions of method 800 are performed by the set of devices 116. In some embodiments, at least portions of method 800 are performed by at least one or more of system 150 or database 162.

In some embodiments, at least portions of method 800 are performed by at least one or more of the set of nodes 110 or the set of devices 116.

In some embodiments, FIG. 8 is a flowchart of a method of operating system 100 of FIG. 1, and similar detailed description is therefore omitted. It is understood that additional operations may be performed before, during, and/or after the method 800 depicted in FIG. 8, and that some other operations may only be briefly described herein. In some embodiments, other order of operations of method 800 is within the scope of the present disclosure. In some embodiments, one or more operations of method 800 are not performed.

Method 800 includes exemplary operations, but the operations are not necessarily performed in the order shown. Operations may be added, replaced, changed order, and/or eliminated as appropriate, in accordance with the spirit and scope of disclosed embodiments. It is understood that method 800 utilizes features of one or more of system 100.

In operation 802 of method 800, for each value of n, k data points in the first set of normalized statistical features 541 are selected in the first database.

In some embodiments, operation 802 includes selecting k data points in the first database whose distance in a 6-dimensional (6D) feature space that are “nearest” to the measured features.

In some embodiments, the k data points are separated by the first set of distances from measured features. In some embodiments, the measured features include the second set of normalized statistical features 741.

In some embodiments, the k data points that are “nearest” to the measured features are separated by a first set of distances from the measured features (e.g., the second set of normalized statistical features 741). In some embodiments, the value of k is greater than or equal to 1.

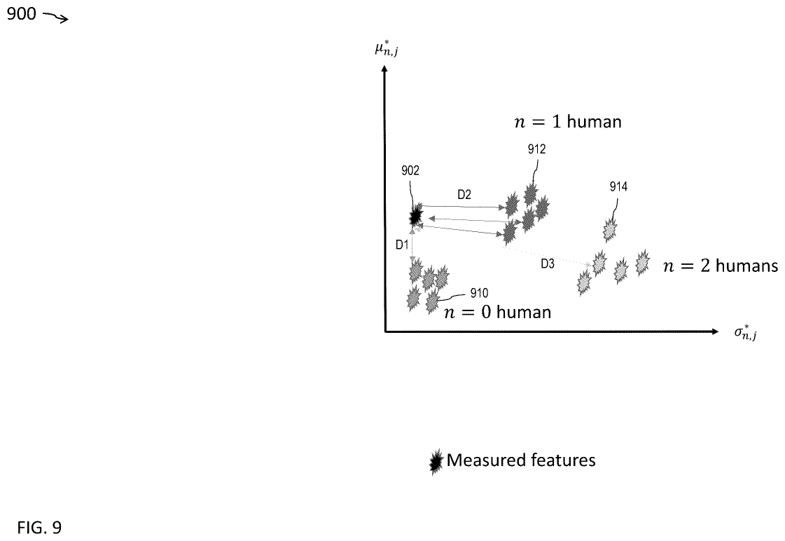

In some embodiments, the first set of distances includes at least one of distance D1, D2, or D3 (shown in FIG. 9).

In operation 804 of method 800, the second set of normalized statistical features 741 is classified to a first class having a value of n.

In some embodiments, operation 804 includes classifying the measured features to the first class having the value of n.

In some embodiments, the first class is the corresponding set of modeled features whose majority of nodes in FIG. 9 are closest to the nodes of the measured features. In some embodiments, a majority of nodes is a number of nodes that is greater than 50% of a total number of nodes. In some embodiments, the majority of nodes is similar to majority voting mechanism.

In some embodiments, operation 804 includes classifying the measured data to the class whose majority of nodes are “nearest” to the nodes of the measured data.

In some embodiments, n is an integer greater than or equal to 1, and corresponds to each number of humans that are modeled in region 101 during performance of operation 208.

In some embodiments, the value of n corresponds to a sub-set of the first set of normalized statistical features 541 having a majority of members closest to the second set of normalized statistical features 741 than other sub-sets of the first set of normalized statistical features 541 with corresponding values of n.

In operation 806 of method 800, the number of people in the first region is estimated based on the first class having the value of n.

In some embodiments, operation 806 includes estimating that the number of people in the first region is based on the measured RSRP that corresponds to the classified class (e.g., first class).

For example, as shown in FIG. 9, the majority of nearest nodes are from the n=1 human class, thus operation 806 estimates that there is 1 human in the first region.

In some embodiments, one or more of the operations of method 800 is not performed.

By utilizing method 800, method 800 achieves the benefits discussed herein.

FIG. 9 is an exemplary diagram 900 that illustrates operations 802-806 of method 800, in accordance with some embodiments.

In some embodiments, diagram 900 illustrates operation 232 of method 200.

Diagram 900 includes a set of nodes 902, a set of nodes 910, a set of nodes 912 and a set of nodes 914.

In some embodiments, the set of nodes 902 is the measured features of method 800, and similar detailed description is omitted.

In some embodiments, the set of nodes 902 is the second set of normalized statistical features 741, and similar detailed description is omitted.

In some embodiments, the set of nodes 910, the set of nodes 912 and the set of nodes 914 are the k data points in the first set of normalized statistical features 541 that are selected in the first database.

In some embodiments, the set of nodes 910 is the n=0 human class.

In some embodiments, the set of nodes 912 is the n=1 human class.

In some embodiments, the set of nodes 914 is the n=2 human class.

In some embodiments, the set of nodes 910 is separated from the set of nodes 902 by a set of distances D1.

In some embodiments, the set of nodes 912 is separated from the set of nodes 902 by a set of distances D2.

In some embodiments, the set of nodes 914 is separated from the set of nodes 902 by a set of distances D3.

As shown in FIG. 9, the set of distances D2 is less than the set of distances D3.

As shown in FIG. 9, the majority of the nearest nodes in the set of nodes 910, 912 or 914 are from the n=1 human class (e.g., the set of nodes 912), thus operation 806 estimates that there is 1 human in the first region.

In some embodiments, while diagram 900 shows a 2D graph, method 800 is configured to use at least of a 2D, 3D, 4D, 5D or 6D graph.

Other configurations of diagram 900 are within the scope of the present disclosure.

FIG. 10 is a block diagram of a system 1000 for crowd counting in accordance with at least one embodiment. In some embodiments, the system 1000 is usable to implement the method 200 (FIGS. 2A-2B), the method 800 (FIG. 8) or another suitable method for crowd counting.

System 1000 includes a hardware processor 1002 and a non-transitory, computer readable storage medium 1004 encoded with, i.e., storing, the computer program code 1006, i.e., a set of executable instructions. Computer readable storage medium 1004 is also encoded with instructions 1007 for interfacing with external devices. The processor 1002 is electrically coupled to the computer readable storage medium 1004 via a bus 1008. The processor 1002 is also electrically coupled to an I/O interface 1010 by bus 1008. A network interface 1012 is also electrically connected to the processor 1002 via bus 1008. Network interface 1012 is connected to a network 1014, so that processor 1002 and computer readable storage medium 1004 are capable of connecting to external elements via network 1014. The processor 1002 is configured to execute the computer program code 1006 encoded in the computer readable storage medium 1004 in order to cause system 1000 to be usable for performing a portion or all of the operations as described in the method 200 (FIGS. 2A-2B), the method 800 (FIG. 8) or the system 100 (FIG. 1).

In some embodiments, the processor 1002 is a central processing unit (CPU), a multi-processor, a distributed processing system, an application specific integrated circuit (ASIC), and/or a suitable processing unit.

In some embodiments, the computer readable storage medium 1004 is an electronic, magnetic, optical, electromagnetic, infrared, and/or a semiconductor system (or apparatus or device). For example, the computer readable storage medium 1004 includes a semiconductor or solid-state memory, a magnetic tape, a removable computer diskette, a random-access memory (RAM), a read-only memory (ROM), a rigid magnetic disk, and/or an optical disk. In some embodiments using optical disks, the computer readable storage medium 1004 includes a compact disk-read only memory (CD-ROM), a compact disk-read/write (CD-R/W), and/or a digital video disc (DVD). In some embodiments, the computer readable storage medium 1004 is part of a cloud storage system.

In some embodiments, the storage medium 1004 stores the computer program code 1006 configured to cause system 1000 to perform a portion or all of the operations as described in the method 200 (FIGS. 2A-2B), the method 800 (FIG. 8) or the system 100 (FIG. 1). In some embodiments, the storage medium 1004 also stores information used for performing a portion or all of the operations as described in the method 200 (FIGS. 2A-2B), the method 800 (FIG. 8) or the system 100 (FIG. 1) as well as information generated during performing a portion or all of the operations as described in the method 200 (FIGS. 2A-2B), the method 800 (FIG. 8) or the system 100 (FIG. 1), such as a kNN algorithm 1016, RSRP parameters 1018, statistic features 1020, a number of people 1022, background data 1024 and/or a set of executable instructions to perform the operation of a portion or all of the operations as described in the method 200 (FIGS. 2A-2B), the method 800 (FIG. 8) or the system 100 (FIG. 1).

In some embodiments, the storage medium 1004 stores instructions 1007 for interfacing with external devices. The instructions 1007 enable processor 1002 to generate images for display to the users of the system 1000.

System 1000 includes I/O interface 1010. I/O interface 1010 is coupled to external circuitry. In some embodiments, I/O interface 1010 includes a keyboard, keypad, mouse, trackball, trackpad, touchscreen and/or cursor direction keys for communicating information and commands to processor 1002.

System 1000 also includes network interface 1012 coupled to the processor 1002. Network interface 1012 allows system 1000 to communicate with network 1014, to which one or more other computer systems are connected. Network interface 1012 includes wireless network interfaces such as BLUETOOTH, WIFI, WIMAX, GPRS, or WCDMA; or wired network interface such as ETHERNET, USB, or IEEE-1394. In some embodiments, method 200, method 800 or the processes described with respect to FIG. 2A-2B or 8 is implemented in two or more systems 1000, and information is exchanged between different systems 1000 via network 1014.

FIG. 11 illustrates an embodiment of a device 1100 for implementing a crowd counting method in accordance with at least one embodiment. As shown in FIG. 11, the device 1100 includes processor 1110, a memory 1120, a storage component 1130, an input component 1140, an output component 1150, a communication interface 1160, and a bus 1170.

The processor 1110, as used herein, means any type of computational circuit that may comprise hardware elements and software elements. The processor 1110 may be embodied as a multi-core processor, a single core processor, or a combination of one or more multi-core processors and/or one or more single core processors, a distributed processing system, or the like. The processor 1110 may be a Central Processing Unit (CPU), a graphics processing unit (GPU), an accelerated processing unit (APU), an application-specific integrated circuit (ASIC), or another type of processing component.

Memory 1120 includes a non-transitory computer readable medium. Memory 1120 includes a random-access memory (RAM), a read only memory (ROM), and/or another type of dynamic or static storage device (e.g., a flash memory, a magnetic memory, and/or an optical memory) that stores information and/or instructions for use by processor 1110. The memory 1120 comprises machine-readable instructions which are executable by the processor 1110. These machine-readable instructions when executed by the processor 1110 cause the processor 1110 to perform one or more method steps of an embodiment described above.

Storage component 1130 stores information and/or software related to the operation and use of the device 1100. For example, storage component 1130 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1140 is configured to receive information, such as user input. For example, the input component 1140 may include, but not be limited to, a touch screen display, a keyboard, a keypad, a mouse, a button, a switch, and/or a microphone. Additionally, or alternatively, the input component 1140 may include a sensor for sensing information (e.g., a global positioning system (GPS), an accelerometer, a gyroscope, and/or an actuator).

Output component 1150 is configured to provide output information from the device 1100. For example, the output component 1150 may be, but not limited to, a display, a speaker, an instruction device to an external device, and/or one or more light-emitting diodes (LEDs).

Communication interface 1160 is an interface that provides a communication connection to other devices, such as external devices and internal devices. The connection by the communication interface 1160 can be a wired connection, a wireless connection, or a combination of wired and wireless connections, and can be a direct connection or an indirect connection via a communication network that exists between the device 1100 and other devices. In other words, the standard of the communication interface 1160 is not limited.

The bus 1170 acts as an interconnect between the processor 1110, the memory 1120, the storage component 1130, the input component 1140, the output component 1150, and the communication interface 1160 of the device 1100. The bus 1170 may include a wired interconnection or a wireless interconnection.

The number and arrangement of components shown in FIG. 11 are provided as an example. In practice, device 1100 may include additional components, fewer components, different components, or differently arranged components than those shown in FIG. 11.

Additionally, or alternatively, a set of components (e.g., one or more components) of device 1100 may perform one or more functions described as being performed by another set of components of device 1100. Further, one or more method steps described in any of the embodiments may be performed utilizing a plurality of devices 1100 in communication with one another.

An aspect of this description includes a method. The method includes performing background data collection in a first region at a first time, the first region does not include any humans at the first time. In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. In some embodiments, the method further includes performing RSRP data collection in the first region for a second time and performing RSRP data processing for a first database, the second time is different from the first time, the first region includes N humans at the second time, where N is an integer greater than or equal to 0. In some embodiments, the performing RSRP data collection in the first region for the second time and the performing RSRP data processing for the first database includes determining, for each window of a first set of windows, a first set of statistical features based on a first set of background RSRP normalization data, and determining, for each window of the first set of windows, a first set of normalized statistical features based on at least the first set of statistical features. In some embodiments, the method further includes performing k-nearest neighbor (kNN) crowd counting based on at least the RSRP data processing. In some embodiments, the performing kNN crowd counting includes estimating a number of people in the first region based on at least a second set of normalized statistical features.

An aspect of this description relates to a system configured to execute a process. The process includes performing background data collection in a first region at a first time, the first region does not include any humans at the first time. In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. In some embodiments, the method further includes performing RSRP data collection in the first region for a second time and performing RSRP data processing for a first database, the second time is different from the first time, the first region includes N humans at the second time, where N is an integer greater than or equal to 0. In some embodiments, the performing RSRP data collection in the first region for the second time and the performing RSRP data processing for the first database includes determining, for each window of a first set of windows, a first set of statistical features based on a first set of background RSRP normalization data, and determining, for each window of the first set of windows, a first set of normalized statistical features based on at least the first set of statistical features. In some embodiments, the method further includes performing k-nearest neighbor (kNN) crowd counting based on at least the RSRP data processing. In some embodiments, the performing kNN crowd counting includes estimating a number of people in the first region based on at least a second set of normalized statistical features.

An aspect of this description relates to a non-transitory computer readable medium configured to cause a system to execute a method. The method includes performing background data collection in a first region at a first time, the first region does not include any humans at the first time. In some embodiments, the performing background data collection in the first region includes determining a first set of time-averaged reference signal received power (RSRP) data for each beam identification (ID) number and a first set of standard deviation data of the time-averaged RSRP for each beam ID number based on a first set of RSRP data. In some embodiments, the method further includes performing RSRP data collection in the first region for a second time and performing RSRP data processing for a first database, the second time is different from the first time, the first region includes N humans at the second time, where N is an integer greater than or equal to 0. In some embodiments, the performing RSRP data collection in the first region for the second time and the performing RSRP data processing for the first database includes determining, for each window of a first set of windows, a first set of statistical features based on a first set of background RSRP normalization data, and determining, for each window of the first set of windows, a first set of normalized statistical features based on at least the first set of statistical features. In some embodiments, the method further includes performing k-nearest neighbor (kNN) crowd counting based on at least the RSRP data processing. In some embodiments, the performing kNN crowd counting includes estimating a number of people in the first region based on at least a second set of normalized statistical features.

What is claimed is:

1. A method, comprising:
performing background data collection in a first region at a first time, the first region does not include any humans at the first time, wherein the performing background data collection in the first region comprises:
determining a first set of time-averaged reference signal received power (RSRP) data for each beam identification (ID) number and a first set of standard deviation data of the time-averaged RSRP for each beam ID number based on a first set of RSRP data;
performing RSRP data collection in the first region for a second time and performing RSRP data processing for a first database, the second time is different from the first time, the first region includes N humans at the second time, where N is an integer greater than or equal to 0, wherein the performing RSRP data collection in the first region for the second time and the performing RSRP data processing for the first database comprises:
determining, for each window of a first set of windows, a first set of statistical features based on a first set of background RSRP normalization data; and
determining, for each window of the first set of windows, a first set of normalized statistical features based on at least the first set of statistical features;
performing k-nearest neighbor (kNN) crowd counting based on at least the RSRP data processing, wherein the performing kNN crowd counting comprises:
estimating a number of people in the first region based on at least a second set of normalized statistical features.

2. The method of claim 1, wherein the performing background data collection in the first region at the first time comprises:
collecting, by a first set of sensors, the first set of RSRP data.

3. The method of claim 2, wherein the performing RSRP data collection in the first region for the second time and the performing RSRP data processing for the first database comprises:
collecting by the first set of sensors, a second set of RSRP data, the second set of RSRP data being divided into the first set of windows, each window of the first set of windows including a corresponding first sub-set of the second set of RSRP data, each sub-set of the corresponding first sub-set of the second set of RSRP data being a corresponding first set of windowed RSRP data; and
performing, for each window of the first set of windows, background RSRP normalization at each beam ID number thereby generating a first set of background RSRP normalization data based on the second set of RSRP data, the first set of time-averaged RSRP data and the first set of standard deviation data.

4. The method of claim 3, wherein the performing RSRP data collection in the first region for the second time and the performing RSRP data processing for the first database further comprises:
storing the first set of normalized statistical features in the first database.

5. The method of claim 4, wherein the performing kNN crowd counting based on at least the RSRP data processing comprises:
collecting by the first set of sensors, a third set of RSRP data for a first duration in the first region;
querying the first database thereby obtaining the first set of time-averaged RSRP data, and generating a second set of background RSRP normalization data based on the third set of RSRP data and the first set of time-averaged RSRP data;
determining a second set of statistical features based on the second set of background RSRP normalization data; and
determining a second set of normalized statistical features based on at least the second set of statistical features.

6. The method of claim 5, wherein the estimating the number of people in the first region comprises:
selecting, for each value of n, k data points in the first set of normalized statistical features in the first database, the k data points are separated by a first set of distances from the second set of normalized statistical features;
classifying the second set of normalized statistical features to a first class having a value of n, where the value of n corresponds to a sub-set of the first set of normalized statistical features having a majority of members closest to the second set of normalized statistical features than other sub-sets of the first set of normalized statistical features with corresponding values of n; and
estimating the number of people in the first region based on the first class having the value of n.

7. The method of claim 6, wherein the first set of normalized statistical features or the second set of normalized statistical features comprises:
a normalized mean;
a normalized standard deviation;
a normalized skewness;
a normalized kurtosis;
a normalized median absolute deviation; and
a normalized average absolute deviation.

8. A system configured to execute a process comprising:
performing background data collection in a first region at a first time, the first region does not include any humans at the first time, wherein the performing background data collection in the first region comprises:
determining a first set of time-averaged reference signal received power (RSRP) data for each beam identification (ID) number and a first set of standard deviation data of the time-averaged RSRP for each beam ID number based on a first set of RSRP data;
performing RSRP data collection in the first region for a second time and performing RSRP data processing for a first database, the second time is different from the first time, the first region includes N humans at the second time, where N is an integer greater than or equal to 0, wherein the performing RSRP data collection in the first region for the second time and the performing RSRP data processing for the first database comprises:
determining, for each window of a first set of windows, a first set of statistical features based on a first set of background RSRP normalization data; and
determining, for each window of the first set of windows, a first set of normalized statistical features based on at least the first set of statistical features;
performing k-nearest neighbor (kNN) crowd counting based on at least the RSRP data processing, wherein the performing kNN crowd counting comprises:
estimating a number of people in the first region based on at least a second set of normalized statistical features.

9. The system of claim 8, wherein the performing background data collection in the first region at the first time comprises:
collecting, by a first set of sensors, the first set of RSRP data.

10. The system of claim 9, wherein the performing RSRP data collection in the first region for the second time and the performing RSRP data processing for the first database comprises:
collecting by the first set of sensors, a second set of RSRP data, the second set of RSRP data being divided into the first set of windows, each window of the first set of windows including a corresponding first sub-set of the second set of RSRP data, each sub-set of the corresponding first sub-set of the second set of RSRP data being a corresponding first set of windowed RSRP data; and
performing, for each window of the first set of windows, background RSRP normalization at each beam ID number thereby generating a first set of background RSRP normalization data based on the second set of RSRP data, the first set of time-averaged RSRP data and the first set of standard deviation data.

11. The system of claim 10, wherein the performing RSRP data collection in the first region for the second time and the performing RSRP data processing for the first database further comprises:
storing the first set of normalized statistical features in the first database.

12. The system of claim 11, wherein the performing kNN crowd counting based on at least the RSRP data processing comprises:
collecting by the first set of sensors, a third set of RSRP data for a first duration in the first region;
querying the first database thereby obtaining the first set of time-averaged RSRP data, and generating a second set of background RSRP normalization data based on the third set of RSRP data and the first set of time-averaged RSRP data;
determining a second set of statistical features based on the second set of background RSRP normalization data; and
determining a second set of normalized statistical features based on at least the second set of statistical features.

13. The system of claim 12, wherein the estimating the number of people in the first region comprises:
selecting, for each value of n, k data points in the first set of normalized statistical features in the first database, the k data points are separated by a first set of distances from the second set of normalized statistical features;
classifying the second set of normalized statistical features to a first class having a value of n, where the value of n corresponds to a sub-set of the first set of normalized statistical features having a majority of members closest to the second set of normalized statistical features than other sub-sets of the first set of normalized statistical features with corresponding values of n; and
estimating the number of people in the first region based on the first class having the value of n.

14. The system of claim 13, wherein the first set of normalized statistical features or the second set of normalized statistical features comprises:
a normalized mean;
a normalized standard deviation;
a normalized skewness;
a normalized kurtosis;
a normalized median absolute deviation; and
a normalized average absolute deviation.

15. A non-transitory computer readable medium configured to cause a system to execute a method comprising:
performing background data collection in a first region at a first time, the first region does not include any humans at the first time, wherein the performing background data collection in the first region comprises:
determining a first set of time-averaged reference signal received power (RSRP) data for each beam identification (ID) number and a first set of standard deviation data of the time-averaged RSRP for each beam ID number based on a first set of RSRP data;
performing RSRP data collection in the first region for a second time and performing RSRP data processing for a first database, the second time is different from the first time, the first region includes N humans at the second time, where N is an integer greater than or equal to 0, wherein the performing RSRP data collection in the first region for the second time and the performing RSRP data processing for the first database comprises:
determining, for each window of a first set of windows, a first set of statistical features based on a first set of background RSRP normalization data; and
determining, for each window of the first set of windows, a first set of normalized statistical features based on at least the first set of statistical features;
performing k-nearest neighbor (kNN) crowd counting based on at least the RSRP data processing, wherein the performing kNN crowd counting comprises:
estimating a number of people in the first region based on at least a second set of normalized statistical features.

16. The non-transitory computer readable medium of claim 15, wherein the performing background data collection in the first region at the first time comprises:
collecting, by a first set of sensors, the first set of RSRP data.

17. The non-transitory computer readable medium of claim 16, wherein the performing RSRP data collection in the first region for the second time and the performing RSRP data processing for the first database comprises:
collecting by the first set of sensors, a second set of RSRP data, the second set of RSRP data being divided into the first set of windows, each window of the first set of windows including a corresponding first sub-set of the second set of RSRP data, each sub-set of the corresponding first sub-set of the second set of RSRP data being a corresponding first set of windowed RSRP data; and
performing, for each window of the first set of windows, background RSRP normalization at each beam ID number thereby generating a first set of background RSRP normalization data based on the second set of RSRP data, the first set of time-averaged RSRP data and the first set of standard deviation data.

18. The non-transitory computer readable medium of claim 17, wherein the performing RSRP data collection in the first region for the second time and the performing RSRP data processing for the first database further comprises:
storing the first set of normalized statistical features in the first database.

19. The non-transitory computer readable medium of claim 18, wherein the performing kNN crowd counting based on at least the RSRP data processing comprises:
collecting by the first set of sensors, a third set of RSRP data for a first duration in the first region;
querying the first database thereby obtaining the first set of time-averaged RSRP data, and generating a second set of background RSRP normalization data based on the third set of RSRP data and the first set of time-averaged RSRP data;
determining a second set of statistical features based on the second set of background RSRP normalization data; and
determining a second set of normalized statistical features based on at least the second set of statistical features.

20. The non-transitory computer readable medium of claim 19, wherein the estimating the number of people in the first region comprises:
selecting, for each value of n, k data points in the first set of normalized statistical features in the first database, the k data points are separated by a first set of distances from the second set of normalized statistical features;
classifying the second set of normalized statistical features to a first class having a value of n, where the value of n corresponds to a sub-set of the first set of normalized statistical features having a majority of members closest to the second set of normalized statistical features than other sub-sets of the first set of normalized statistical features with corresponding values of n; and
estimating the number of people in the first region based on the first class having the value of n.
